(19) United States
(12) Patent Application Publication
(10) Pub. No.: US 2019/0082255 A1
(43) Pub. Date: Mar. 14, 2019

(54) INFORMATION ACQUIRING APPARATUS, INFORMATION ACQUIRING METHOD, AND COMPUTER READABLE RECORDING MEDIUM

(71) Applicant: OLYMPUS CORPORATION, Tokyo (JP)

(72) Inventors: Kazuma TAJIRI, Tokyo (JP); Junichi UCHIDA, Tokyo (JP); Tadashi HORIUCHI, Tokyo (JP); Takahiro NAKADAI, Tokyo (JP)

(73) Assignee: OLYMPUS CORPORATION, Tokyo (JP)

(21) Appl. No.: 16/122,500

(22) Filed: Sep. 5, 2018

(30) Foreign Application Priority Data
Sep. 8, 2017 (JP) 2017-173163
Sep. 15, 2017 (JP) 2017-177961

(51) Int. Cl. H04R 1/40; H04R 3/00; H04R 29/00; G10L 25/90

(52) U.S. Cl. CPC H04R 1/406; G10L 25/90; H04R 29/005; H04R 3/005

(57) ABSTRACT

A disclosed information acquiring apparatus includes a display that displays an image thereon; a plurality of microphones provided at different positions to collect a sound produced by each of audio sources and generate audio data; an audio-source position estimating circuit that estimates a position of each of the audio sources based on the audio data generated by each of the microphones; and a display control circuit that causes the display to display audio-source positional information about a position of each of the audio sources in accordance with an estimation result estimated by the audio-source position estimating circuit.

### CROSS REFERENCES TO RELATED APPLICATIONS

This application is based upon and claims the benefit of priority from Japanese Patent Application No. 2017-173163, filed on Sep. 8, 2017 and Japanese Patent Application No. 2017-177961, filed on Sep. 15, 2017, the entire contents of which are incorporated herein by reference. su

### BACKGROUND

This disclosure relates to an information acquiring apparatus, a display method, and a computer readable recording medium.

In recent years, there has been a known technology for identifying the position of an audio source by using a plurality of microphone arrays (for example, Japanese Laid-open Patent Publication No. 2012-211768). According to this technology, based on each of audio source signals obtained from output of the microphone arrays and the positional relation of each of the microphone arrays, MUSIC power is calculated at predetermined time intervals with respect to each of directions defined in a space whose center is a point determined in relation to the positions of the microphone arrays, the peak of the MUSIC power is identified as an audio source position, and then an audio signal at the audio source position is separated from an output signal of the microphone array.

### SUMMARY

According to a first aspect of the present disclosure, an information acquiring apparatus is provided which includes a display that displays an image thereon; a plurality of microphones provided at different positions to collect a sound produced by each of audio sources and generate audio data; an audio-source position estimating circuit that estimates a position of each of the audio sources based on the audio data generated by each of the microphones; and a display control circuit that causes the display to display audio-source positional information about a position of each of the audio sources in accordance with an estimation result estimated by the audio-source position estimating circuit.

According to a second aspect of the present disclosure, a display method implemented by an information acquiring apparatus is provided which includes estimating positions of audio sources based on audio data generated by each of microphones that are provided at different positions to collect a sound generated by each of the audio sources and generate audio data; and causing the display to display audio-source positional information about a position of each of the audio sources in accordance with an estimation result estimated.

According to a third aspect of the present disclosure, a non-transitory computer-readable recording medium having an executable program recorded is provided. The program giving a command to a processor included in an information acquiring apparatus executes estimating positions of audio sources based on audio data generated by each of microphones that are provided at different positions to collect a sound produced by each of the audio sources and generate audio data; and causing the display to display audio-source positional information about a position of each of the audio sources in accordance with an estimation result estimated.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a diagram that illustrates a schematic configuration of a transcriber system according to a first embodiment;

FIG. 2 is a block diagram that illustrates a functional configuration of the transcriber system according to the first embodiment;

FIG. 3 is a flowchart that illustrates the outline of a process performed by an information acquiring apparatus according to the first embodiment;

FIG. 4 is a diagram that illustrates a usage scene of the information acquiring apparatus according to the first embodiment;

FIG. 5 is an overhead view that schematically illustrates the situation of FIG. 4;

FIG. 6 is a diagram that schematically illustrates the positions of the audio sources estimated by an audio-source position estimating circuit according to the first embodiment;

FIG. 7 is a diagram that schematically illustrates a calculation situation where the audio-source position estimating circuit according to the first embodiment calculates an arrival time difference with respect to a single audio source;

FIG. 8 is a diagram that schematically illustrates an example of a calculation method for calculating an arrival time difference, calculated by the audio-source position estimating circuit according to the first embodiment;

FIG. 9 is a flowchart that illustrates the outline of each audio-source position display determination process of FIG. 3;

FIG. 10 is a flowchart that illustrates the outline of an icon determination and generation process of FIG. 9;

FIG. 11 is a diagram that schematically illustrates an example of the icon generated by an audio-source information generating circuit according to the first embodiment;

FIG. 12 is a diagram that schematically illustrates another example of the icon generated by an audio-source information generating circuit according to the first embodiment;

FIG. 13 is a diagram that schematically illustrates another example of the icon generated by an audio-source information generating circuit according to the first embodiment;

FIG. 14 is a diagram that schematically illustrates an example of audio-source position information displayed by a display control circuit according to the first embodiment;

FIG. 15 is a flowchart that illustrates the outline of a process performed by an information processing apparatus according to the first embodiment;

FIG. 16 is a diagram that schematically illustrates an example of a document creation screen according to the first embodiment;

FIG. 17 is a flowchart that illustrates the outline of a keyword determination process of FIG. 15;

FIG. 18 is a diagram that schematically illustrates another example of the document creation screen according to the first embodiment;

FIG. 19 is a diagram that schematically illustrates another example of the document creation screen according to the first embodiment;

FIG. 20 is a diagram that schematically illustrates another example of the document creation screen according to the first embodiment;

FIG. 21 is a schematic diagram that illustrates a schematic configuration of an information acquiring system according to a second embodiment;

FIG. 22 is a schematic diagram that illustrates a schematic configuration of the information acquiring system according to the second embodiment;

FIG. 23 is a schematic diagram that partially illustrates the relevant part of the information acquiring system according to the second embodiment;

FIG. 24 is a top view of the information acquiring apparatus when viewed in the IV direction of FIG. 23;

FIG. 25 is a bottom view of an external microphone when viewed in the V direction of FIG. 23;

FIG. 26 is a schematic diagram that partially illustrates the relevant part of the information acquiring system according to the first embodiment;

FIG. 27 is a top view of the information acquiring apparatus when viewed in the VII direction of FIG. 26;

FIG. 28 is a bottom view of the external microphone when viewed in the VIII direction of FIG. 26;

FIG. 29 is a block diagram that illustrates the functional configuration of the information acquiring apparatus according to the second embodiment;

FIG. 30 is a flowchart that illustrates the outline of a process performed by the information acquiring apparatus according to the second embodiment;

FIG. 31 is a flowchart that illustrates the outline of an external-microphone setting process of FIG. 30;

FIG. 32 is a diagram that schematically illustrates the arrival times of two audio sources in the same distance;

FIG. 33 is a diagram that schematically illustrates a calculation situation where the audio-source position estimating circuit calculates an arrival time difference with respect to a single audio source in the circumstance of FIG. 32;

FIG. 34 is a diagram that schematically illustrates an example of an audio file generated by an audio-file generating circuit according to the second embodiment;

FIG. 35 is a schematic diagram that partially illustrates the relevant part of an information acquiring system according to a third embodiment;

FIG. 36 is a top view of the information acquiring apparatus when viewed in the XXVII direction of FIG. 35;

FIG. 37 is a bottom view of an external microphone when viewed in the XXVIII direction of FIG. 35;

FIG. 38 is a schematic diagram that partially illustrates the relevant part of the information acquiring system according to the third embodiment;

FIG. 39 is a top view of the information acquiring apparatus when viewed in the XXX direction of FIG. 38;

FIG. 40 is a bottom view of the external microphone when viewed in the XXXI direction of FIG. 38;

FIG. 41 is a schematic diagram that illustrates a state where the external microphone according to the third embodiment is attached to the information acquiring apparatus in a parallel state;

FIG. 42 is a schematic diagram that illustrates a state where the external microphone according to the third embodiment is attached to the information acquiring apparatus in a perpendicular state;

FIG. 43 is a block diagram that illustrates the functional configuration of the information acquiring apparatus according to the third embodiment;

FIG. 44 is a flowchart that illustrates the outline of the external-microphone setting process performed by the information acquiring apparatus according to the third embodiment;

FIG. 45 is a schematic diagram that partially illustrates the relevant part of the information acquiring system according to a fourth embodiment;

FIG. 46 is a top view of the information acquiring apparatus when viewed in the XXXVII direction of FIG. 45;

FIG. 47 is a bottom view of the external microphone when viewed in the XXXVIII direction of FIG. 45;

FIG. 48 is a schematic diagram that partially illustrates the relevant part of the information acquiring system according to the fourth embodiment;

FIG. 49 is a top view of the information acquiring apparatus when viewed in the XXXX direction of FIG. 48;

FIG. 50 is a bottom view of the external microphone when viewed in the XXXXI direction of FIG. 48;

FIG. S1 is a schematic diagram that illustrates a state where the external microphone according to the fourth embodiment is attached to the information acquiring apparatus in a parallel state; and

FIG. 52 is a schematic diagram that illustrates a state where the external microphone according to the fourth embodiment is attached to the information acquiring apparatus in a perpendicular state.

### DETAILED DESCRIPTIONS

With reference to drawings, a detailed explanation is given below of an aspect (hereafter, referred to “embodiment”) for implementing this disclosure. Furthermore, this disclosure is not limited to embodiments below. Moreover, in drawings referred to in the following explanation, shapes, sizes, and positional relations are illustrated schematically only to understand the details of this disclosure. That is, this disclosure is not limited to shapes, sizes, and positional relations illustrated in the drawings only.

### First Embodiment

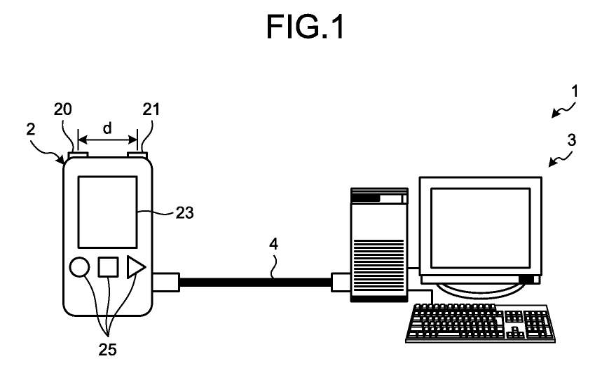

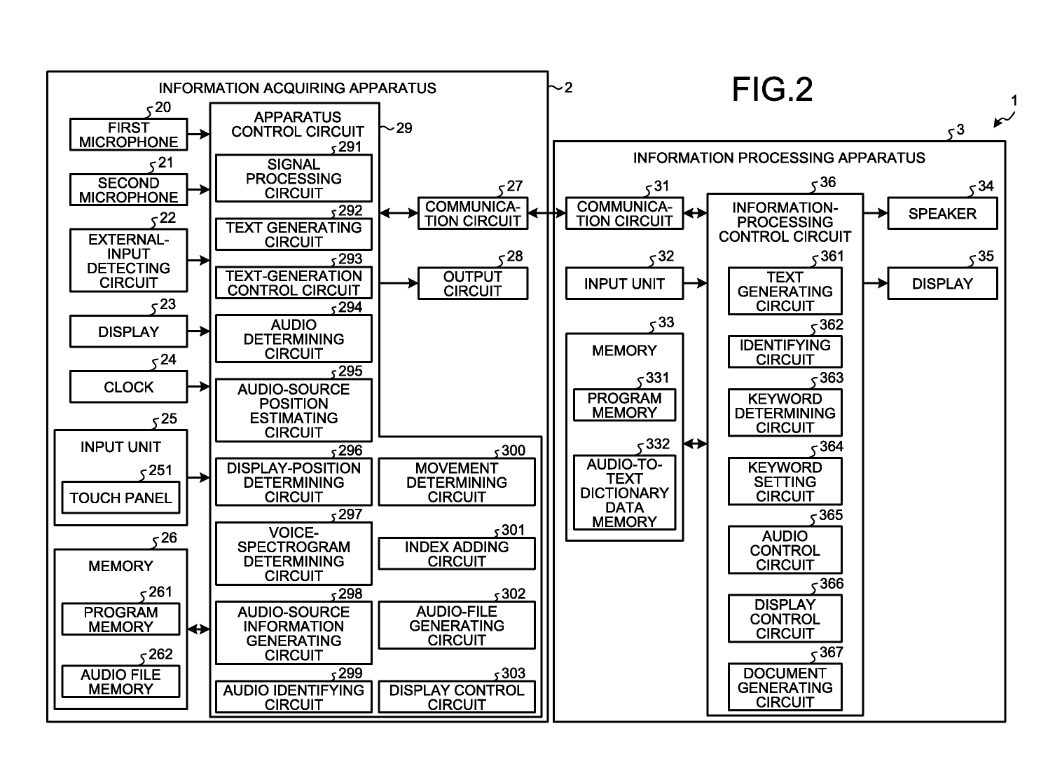

Configuration of transcriber system FIG. 1 is a diagram that illustrates a schematic configuration of a transcriber system according to the first embodiment. FIG. 2 is a block diagram that illustrates a functional configuration of the transcriber system according to the first embodiment.

A transcriber system 1 illustrated in FIGS. 1 and 2 includes an information acquiring apparatus 2 that functions as a recording apparatus, such as a digital voice recorder that receives voices through, for example, a microphone, and records audio data, or a mobile phone that receives voices through, for example, a microphone, and records audio data; and an information processing apparatus 3 such as a personal computer that acquires audio data from the information acquiring apparatus 2 via a communication cable 4 and transcribes audio data or performs various processes. Here, according to the first embodiment, the information acquiring apparatus 2 and the information processing apparatus 3 communicate with each other bidirectionally via the communication cable 4; however, this is not a limitation, and they may be communicatively connected to each other bidirectionally via radio waves. In this case, the radio communication standard is IEEE802.11a, IEEE802.11b, IEEE802.11n, IEEE802.11g, IEEE802.11ac, Bluetooth (registered trademark), an infrared communication standard, or the like.

Configuration of the Information Acquiring Apparatus

First, the configuration of the information acquiring apparatus 2 is explained.

The information acquiring apparatus 2 includes a first microphone 20, a second microphone 21, an external-input detecting circuit 22, a display 23, a clock 24, an input unit 25, a memory 26, a communication circuit 27, an output circuit 28, and an apparatus control circuit 29.

The first microphone 20 is provided on the left side of the top of the information acquiring apparatus 2 (see FIG. 1). The first microphone 20 collects a sound produced by each of audio sources, converts the sound into an analog audio signal (electric signal), performs A/D conversion processing or gain adjustment processing on the audio signal to generate digital audio data (first audio data), and outputs the generated digital audio data to the apparatus control circuit 29. The first microphone 20 is configured by using any one of a unidirectional microphone, a non-directional microphone, and a bidirectional microphone, an A/D conversion circuit, a signal processing circuit, and the like.

The second microphone 21 is provided at a position different from the first microphone 20. The second microphone 21 is provided on the right side of the top of the information acquiring apparatus 2 away from the first microphone 20 by a predetermined distance d (see FIG. 1). The second microphone 21 collects a sound produced by each of audio sources, converts the sound into an analog audio signal (electric signal), performs A/D conversion processing or gain adjustment processing on the audio signal to generate digital audio data (second audio data), and outputs the generated digital audio data to the apparatus control circuit 29. The second microphone 21 has the same configuration as that of the first microphone 20, and is configured by using any one of a unidirectional microphone, a non-directional microphone, and a bidirectional microphone, an A/D conversion circuit, a signal processing circuit, and the like. Here, according to the first embodiment, the first microphone 20 and the second microphone 21 constitute a stereo microphone.

The external-input detecting circuit 22 has a plug of an external microphone inserted from outside the information acquiring apparatus 2 inserted into or removed from itself, detects that the external microphone is inserted, and outputs a detection result to the apparatus control circuit 29. Furthermore, the external-input detecting circuit 22 receives an input of an analog audio signal (electric signal) generated after the external microphone collects the sound produced by each of the audio sources, performs A/D conversion processing or gain adjustment processing on the audio signal whose input has been received to generate digital audio data (at least including third audio data), and outputs the generated digital audio data to the apparatus control circuit 29. Furthermore, when the plug of the external microphone is inserted, the external-input detecting circuit 22 outputs the signal indicating that the external microphone is connected to the information acquiring apparatus 2 to the apparatus control circuit 29 and outputs audio data generated by the external microphone to the apparatus control circuit 29. The external-input detecting circuit 22 is configured by using a microphone jack, an A/D conversion circuit, a signal processing circuit, and the like. Furthermore, the external microphone is configured by using any of a unidirectional microphone, a non-directional microphone, a bidirectional microphone, a stereo microphone capable of collecting sounds from right and left, and the like. When a stereo microphone is used as the external microphone, the external-input detecting circuit 22 generates two pieces of audio data (third audio data and fourth audio data) collected by each of the microphones on right and left and outputs the generated audio data to the apparatus control circuit 29.

The display 23 displays various types of information related to the information acquiring apparatus 2 under the control of the apparatus control circuit 29. The display 23 is configured by using an organic electro luminescence (EL), a liquid crystal, or the like.

The clock 24 has a time measurement function and also generates time and date information about the time and date of audio data generated by each of the first microphone 20, the second microphone 21, and an external microphone and outputs the time and date information to the apparatus control circuit 29.

The input unit 25 receives input of various types of information regarding the information acquiring apparatus 2. The input unit 25 is configured by using a button, switch, or the like. Furthermore, the input unit 25 includes a touch panel 251 that is provided on the display area of the display 23 in an overlapped manner to detect a contact with an object from outside and receive input of an operating signal that corresponds to the position detected.

The memory 26 is configured by using a volatile memory, a nonvolatile memory, a recording medium, or the like, and stores audio files containing audio data and various programs executed by the information acquiring apparatus 2. The memory 26 includes: a program memory 261 that stores various programs executed by the information acquiring apparatus 2; and an audio file memory 262 that stores audio files containing audio data. Here, the memory 26 may be a recording medium such as a memory card that is attached to or detached from outside.

The communication circuit 27 transmits data including audio files containing audio data to the information processing apparatus 3 in accordance with a predetermined communication standard and receives various types of information and data from the information processing apparatus 3.

The output circuit 28 conducts D/A conversion processing on digital audio data input from the apparatus control circuit 29, converts the digital audio data into an analog audio signal, and outputs the analog audio signal to an external unit. The output circuit 28 is configured by using a speaker, a D/A conversion circuit, or the like.

The apparatus control circuit 29 controls each unit included in the information acquiring apparatus 2 in an integrated manner. The apparatus control circuit 29 is configured by using a central processing unit (CPU), a field programmable gate array (FPGA), or the like. The apparatus control circuit 29 includes a signal processing circuit 291, a text generating circuit 292, a text-generation control circuit 293, an audio determining circuit 294, an audio-source position estimating circuit 295, a display-position determining circuit 296, a voice-spectrogram determining circuit 297, an audio-source information generating circuit 298, an audio identifying circuit 299, a movement determining circuit 300, an index adding circuit 301, an audio-file generating circuit 302, and a display control circuit 303.

The signal processing circuit 291 conducts adjustment processing, noise reduction processing, gain adjustment processing, or the like, on the audio level of audio data generated by the first microphone 20 and the second microphone 21.

The text generating circuit 292 conducts sound recognition processing on audio data to generate audio text data that is configured by using multiple texts. The details of the sound recognition processing are described later.

When input of a command signal causing the text generating circuit 292 to generate audio text data is received from the input unit 25, the text-generation control circuit 293 causes the text generating circuit 292 to generate audio text data during a predetermined time period starting from the time when the input of the command signal is received.

The audio determining circuit 294 determines whether a silent period is included in audio data on which the signal processing circuit 291 has sequentially conducted automatic level adjustment. Specifically, the audio determining circuit 294 determines whether the audio level of audio data is less than a predetermined threshold and determines that the time period during which the audio level of audio data is less than the predetermined threshold is a silent period.

The audio-source position estimating circuit 295 estimates the positions of audio sources on the basis of the audio data produced by each of the first microphone 20 and the second microphone 21. Specifically, based on the audio data produced by each of the first microphone 20 and the second microphone 21, a difference between arrival times at which audio signals produced by the respective audio sources arrive at the first microphone 20 and the second microphone 21, respectively, is calculated, and in accordance with a calculation result, the position of each of the audio sources is estimated with the information acquiring apparatus 2 at the center.

The display-position determining circuit 296 determines the display position of each of the audio sources on the display area of the display 23 in accordance with the shape of the display area of the display 23 and an estimation result estimated by the audio-source position estimating circuit 295. Specifically, the display-position determining circuit 296 determines the display position of each of the audio sources when the information acquiring apparatus 2 is in the center of the display area of the display 23. For example, the display-position determining circuit 296 divides the display area of the display 23 into four quadrants and determines the display position of each of the audio sources when the information acquiring apparatus 2 is placed at the center of the display area of the display 23.

The voice-spectrogram determining circuit 297 determines the voice spectrogram from each of the audio sources on the basis of audio data. Specifically, the voice-spectrogram determining circuit 297 determines the voice spectrogram (speaker) from each of the audio sources included in audio data. For example, before recording of a conference is conducted by using the information acquiring apparatus 2, the voice-spectrogram determining circuit 297 determines the voice spectrogram (speaker) from each of the audio sources included in audio data in accordance with the speaker identifying template that registers characteristics based on voices produced by a speaker who participates in the conference. Furthermore, in addition to the characteristics based on voices produced by speakers, the voice-spectrogram determining circuit 297 determines the level of frequency (pitch of voice), intonation, volume of voice (intensity), histogram, or the like, based on audio data. The voice-spectrogram determining circuit 297 may determine a sex based on audio data. Additionally, the voice-spectrogram determining circuit 297 may determine a volume of voice (intensity) or a level of frequency (a pitch of voice) in each speech produced by each of speakers, regarding each of the speakers, on the basis of audio data. Moreover, the voice-spectrogram determining circuit 297 may determine intonation in each speech produced by each of the speakers, regarding each of the speakers, on the basis of audio data.

The audio-source information generating circuit 298 generates multiple pieces of audio source information regarding each of the audio sources in accordance with a determination result determined by the voice-spectrogram determining circuit 297. Specifically, the audio-source information generating circuit 298 generates audio information on each of the speakers in accordance with a determination result produced by the voice-spectrogram determining circuit 297, based on each speech produced by the speakers. For example, the audio-source information generating circuit 298 generates, as the audio information, the icon schematically illustrating a speaker on the basis of a level of frequency (a pitch of voice) produced by a speaker. Here, the audio-source information generating circuit 298 may variably generate a type of audio information in accordance with the sex determined by the voice-spectrogram determining circuit 297, e.g., an icon such as female icon, male icon, dog, or cat. Here, the audio-source information generating circuit 298 may prepare data on a specific pitch of voice as a database and compare the data with an acquired voice signal thereby to determine an icon, or may determine an icon by comparing levels of frequencies of voices (pitches of voices), or the like, among plural speakers detected. Furthermore, the audio-source information generating circuit 298 may make a database of types of used words, expressions, and the like, by gender, language, age, or the like, and compare these attributes with an audio pattern to determine an icon. Furthermore, there is a problem as to whether an icon is created for a person who says something that is not relevant or who only gives a nod. Often, such a statement hardly needs to be listened to later, and is an additional statement to the primary statement; therefore, there is little point for the audio-source information generating circuit 298 to generate the icon. Intuitive determinations are sometimes improper. Thus, when a statement does not have a length more than a specific time length or when noun such as a subject or an object, verb, adjective, or auxiliary verb, is uncertain, the audio-source information generating circuit 298 may regard such utterance as an ambiguous statement rather than an important statement and may not create an icon of the speaker or may make a different visibility by diluting an icon, presenting the icon as a dotted line, reducing its size, or breaking the middle of a line forming an icon. That is, the audio-source information generating circuit 298 may be provided with a function to determine the contents of a speech through sound recognition, determine the words used, and grammatically verify the degree of completeness of the speech so as to determine whether an appropriate object or subject is used for the topic for discussion. It may be determined whether it is a word related to the topic for discussion by detecting whether a similar word is used in the contents of a speech of a principal speaker (chairperson or facilitator) and comparing the word concerned to words made by each speaker. When the comparison is unsuccessful, the word may be determined to be an unclear statement. Alternatively, it may be determined that a voice is small or a speech is short. By taking measures described above, icons schematically illustrating corresponding speakers in visibly different forms are generated on the basis of the length or the clarity of a voice produced by the speaker from audio source information generated regarding each speaker, based on each speech produced by corresponding one of the speakers, whereby intuitive search performance of speeches is improved. Furthermore, the audio-source information generating circuit 298 may generate, as the audio source information, the icon schematically illustrating each of the speakers based on a comparison between volumes of voices of the respective speakers determined by the voice-spectrogram determining circuit 297. The audio-source information generating circuit 298 may generate audio source information with different icons schematically illustrating speakers on the basis of the length of a voice and the volume of a voice, regarding each speaker, in each speech produced by each of the speakers, based on audio data.

The audio identifying circuit 299 identifies an appearance position (appearance time) in which each of voice spectrograms, determined by the voice-spectrogram determining circuit 297, appears in audio data.

The movement determining circuit 300 determines whether each of the audio sources is moving in accordance with an estimation result estimated by the audio-source position estimating circuit 295 and a determination result determined by the voice-spectrogram determining circuit 297.

The index adding circuit 301 adds an index to at least one of the beginning and the end of a silent period determined by the audio determining circuit 294 to distinguish between the silent period and other periods in audio data.

The audio-file generating circuit 302 generates an audio file that relates audio data on which the signal processing circuit 291 has conducted signal processing, audio-source positional information estimated by the audio-source position estimating circuit 295, multiple pieces of audio source information generated by the audio-source information generating circuit 298, the appearance position identified by the audio identifying circuit 299, the positional information on the position of the index added by the index adding circuit 301 or the time information on the time of an index added in the audio data, and audio text data generated by the text generating circuit 292, and stores the audio file in the audio file memory 262. Furthermore, the audio-file generating circuit 302 may generate an audio file that relates audio data on which the signal processing circuit 291 has conducted signal processing and candidate timing information that defines candidate timing in which the text generating circuit 292 generates audio text data during a predetermined time period after the input unit 25 receives input of a command signal and stores the audio file in the audio file memory 262 that functions as a recording medium.

The display control circuit 303 controls a display mode of the display 23. Specifically, the display control circuit 303 causes the display 23 to display various types of information regarding the information acquiring apparatus 2. For example, the display control circuit 303 causes the display 23 to display the audio level of audio data adjusted by the signal processing circuit 291. Furthermore, the display control circuit 303 causes the display 23 to display audio-source positional information about the position of each of the audio sources in accordance with an estimation result estimated by the audio-source position estimating circuit 295. Specifically, the display control circuit 303 causes the display 23 to display audio-source positional information in accordance with a determination result determined by the display-position determining circuit 296. More specifically, the display control circuit 303 causes the display 23 to display, as the audio-source positional information, multiple pieces of audio source information generated by the audio-source information generating circuit 298.

Configuration of the Information Processing Apparatus

Next, the configuration of the information processing apparatus 3 is explained.

The information processing apparatus 3 includes a communication circuit 31, an input unit 32, a memory 33, a speaker 34, a display 35, and an information-processing control circuit 36.

In accordance with a predetermined communication standard, the communication circuit 31 transmits data to the information acquiring apparatus 2 and receives data including audio files containing at least audio data from the information acquiring apparatus 2.

The input unit 32 receives input of various types of information regarding the information processing apparatus 3. The input unit 32 is configured by using a button, switch, keyboard, touch panel, or the like. For example, the input unit 32 receives input of text data when a user conducts operation to create a document.

The memory 33 is configured by using a volatile memory, a nonvolatile memory, a recording medium, or the like, and stores audio files containing audio data and various programs executed by the information processing apparatus 3. The memory 33 includes: a program memory 331 that stores various programs executed by the information processing apparatus 3; and an audio-to-text dictionary data memory 332 that is used to convert audio data into text data. The audio-to-text dictionary data memory 332 is preferably a database that enables search for synonyms in addition to relations between sound and text. Here, synonyms are two or more words that have different word forms but have a similar meaning in the same language and, in some cases, interchangeable. Thesaurus and quasi-synonyms may be included.

The speaker 34 conducts D/A conversion processing on digital audio data input from the information-processing control circuit 36 to convert the digital audio data into an analog audio signal and outputs the analog audio signal to an external unit. The speaker 34 is configured by using an audio processing circuit, a D/A conversion circuit, or the like.

The display 35 diplays various types of information regarding the information processing apparatus 3 and the time bar that corresponds to the recording time of audio data under the control of the information-processing control circuit 36. The display 35 is configured by using an organic EL, a liquid crystal, or the like.

The information-processing control circuit 36 controls each unit included in the information processing apparatus 3 in an integrated manner. The information-processing control circuit 36 is configured by using a CPU, or the like. The information-processing control circuit 36 includes a text generating circuit 361, an identifying circuit 362, a keyword determining circuit 363, a keyword setting circuit 364, an audio control circuit 365, a display control circuit 366, and a document generating circuit 367.

The text generating circuit 361 conducts sound recognition processing on audio data to generate audio text data that is made up of multiple texts. Furthermore, the details of the sound recognition processing are described later.

The identifying circuit 362 identifies the appearance position (appearance time) in audio data in which a character string of a keyword matches a character string in audio text data. A character string of a keyword does not need to completely match a character string in audio text data, and, for example, the identifying circuit 362 may identify the appearance position (appearance time) in audio data in which there is a high degree of similarity (e.g., equal to or more than 80%) between a character string of a keyword and a character string in audio text data.

The keyword determining circuit 363 determines whether an audio file acquired by the communication circuit 31 from the information acquiring apparatus 2 contains a keyword candidate. Specifically, the keyword determining circuit 363 determines whether an audio file acquired by the communication circuit 31 from the information acquiring apparatus 2 contains audio text data.

When the keyword determining circuit 363 determines that the audio file acquired from the information acquiring apparatus 2 via the communication circuit 31 contains a keyword candidate, the keyword setting circuit 364 sets the keyword candidate contained in the audio file as a keyword for retrieving an appearance position in audio data. Specifically, the keyword setting circuit 364 sets audio text data contained in the audio file acquired by the communication circuit 31 from the information acquiring apparatus 2 as a keyword for retrieving an appearance position in audio data. After a conference is finished, the accurate word is often forgotten although the word is vaguely remembered; therefore, the keyword setting circuit 364 may conduct dictionary search for a synonym (for example, when the word is “significant”, a similar word such as “point” or “important”) in a database (the audio-to-text dictionary data memory 332), or the like, to search for a keyword having a similar meaning.

The audio control circuit 365 controls the speaker 34. Specifically, the audio control circuit 365 causes the speaker 34 to reproduce audio data contained in an audio file.

The display control circuit 366 controls a display mode of the display 35. The display control circuit 366 causes the display 35 to display the positional information about the appearance position at which a keyword appears in the time bar.

Process of the Information Acquiring Apparatus

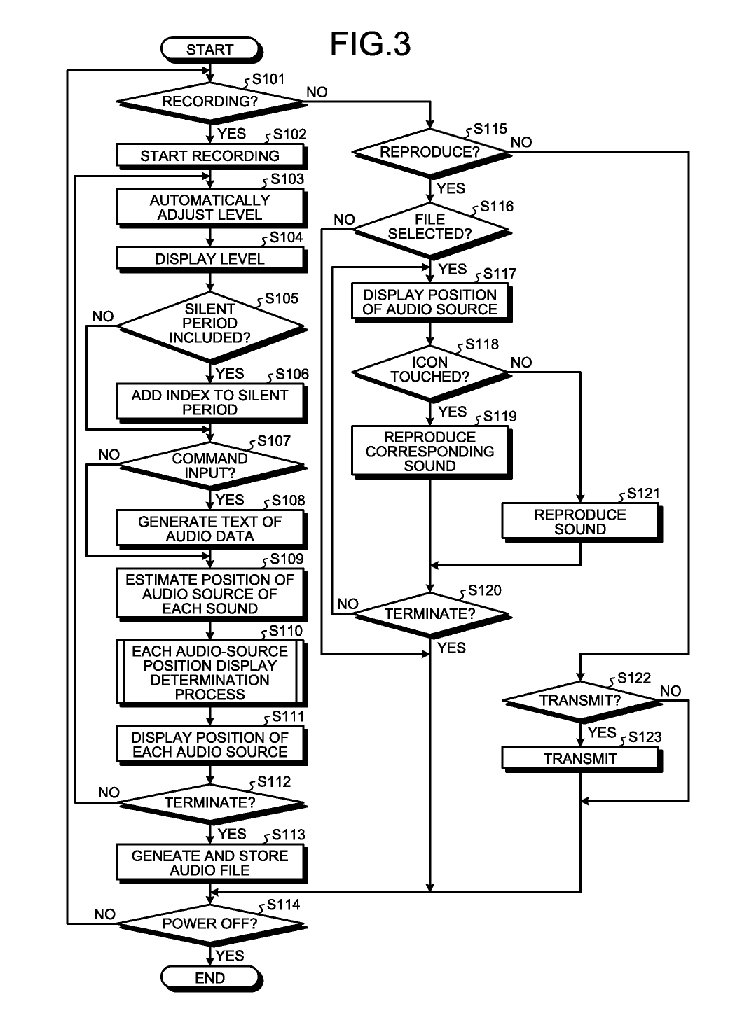

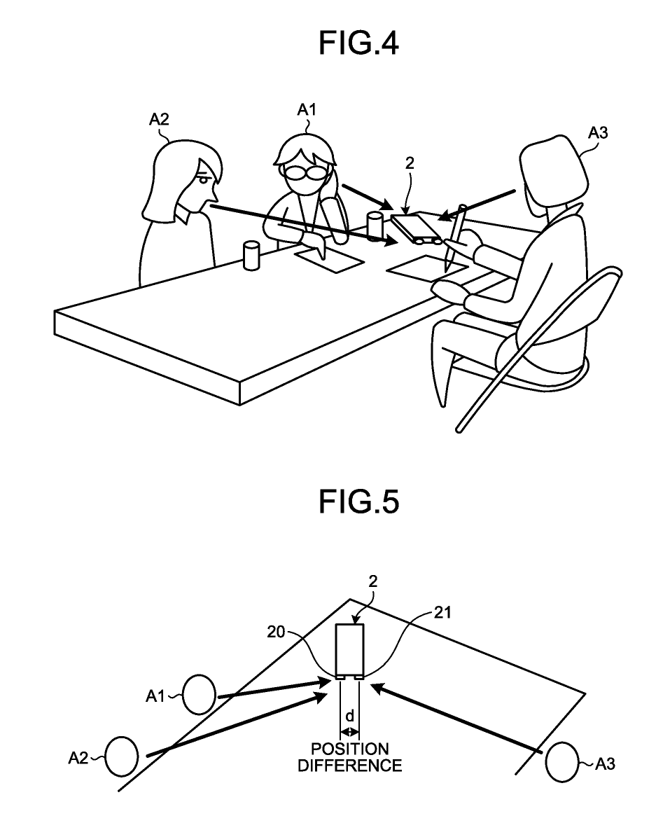

Next, a process performed by the information acquiring apparatus 2 is explained. FIG. 3 is a flowchart that illustrates the outline of the process performed by the information acquiring apparatus 2. FIG. 4 is a diagram that illustrates a usage scene of the information acquiring apparatus 2. FIG. 5 is an overhead view that schematically illustrates the situation of FIG. 4.

As illustrated in FIG. 3, when a command signal to give a command for recording has been input from the input unit 25 due to operation on the input unit 25 (Step S101: Yes), the apparatus control circuit 29 drives the first microphone 20 and the second microphone 21 to start recording by sequentially storing audio data in an audio file in accordance with input of a voice and recording the voice in the memory 26 (Step S102).

Then, the signal processing circuit 291 conducts automatic level adjustment to automatically adjust the level of audio data produced by each of the first microphone 20 and the second microphone 21 (Step S103).

Then, the display control circuit 303 causes the display 23 to display the level of automatic level adjustment conducted on the audio data by the signal processing circuit 291 (Step S104).

Then, the audio determining circuit 294 determines whether the audio data on which automatic level adjustment has been sequentially conducted by the signal processing circuit 29 includes a silent period (Step S105). Specifically, the audio determining circuit 294 determines whether a silent period is included by determining whether the volume level is less than a predetermined threshold in each predetermined frame period of audio data on which the signal processing circuit 291 sequentially conducts automatic level adjustment. More specifically, the audio determining circuit 294 determines that the audio data contains a silent period, when the time period during which the volume level of the audio data is less than a predetermined threshold is a predetermined time period (e.g., 10 seconds). Here, the predetermined time period may be appropriately set by a user using the input unit 25. When the audio determining circuit 294 determines that a silent period is included in audio data on which the signal processing circuit 291 sequentially conducts automatic level adjustment (Step S105: Yes), the process proceeds to Step S106 described later. Conversely, the audio determining circuit 294 determines that no silent period is included in audio data on which the signal processing circuit 291 sequentially conducts automatic level adjustment (Step S105: No), the process proceeds to Step S107 described later.

At Step S106, the index adding circuit 301 adds an index to at least any of the beginning and the end of a silent period determined by the audio determining circuit 294 to distinguish the silent period from other periods in the audio data. After Step S106, the process proceeds to Step S107 described later.

At Step S107, when a command signal to give a command to set a keyword candidate for adding an index has been input from the input unit 25 due to operation on the input unit 25 (Step S107: Yes), the process proceeds to Step S108 described later. Conversely, when no command signal to give a command to set a keyword candidate for adding an index has been input from the input unit 25 (Step S107: No), the process proceeds to Step S109 described later. This step corresponds to a case where a user gives some command, which is analogous to a note, a sticky, or the like, used to leave a mark on an important point, when an important topic that needs to be listened to later gets underway in the middle of recording such as in the middle of a conference. Here, a specific switch operation (e.g., an input due to operation on the input unit 25) is described; however, a similar input may be made after a voice such as “this is important” is detected. That is, the index adding circuit 301 may add an index on the basis of text data on the text that is generated by the text generating circuit 292 from audio data input via the first microphone 20 and the second microphone 21.

At such timing, there is a high possibility that the discussion has then started with the word that is an important keyword in the conference; therefore, at Step S108, on the audio data that is returned to an earlier point by a predetermined time period (e.g., 3 seconds, a process may be performed to return to a further earlier point when a conversation is continuing) after the input unit 25 inputs a command signal to give a command to set a keyword candidate, the text-generation control circuit 293 causes the text generating circuit 292 to perform the sound recognition processing described later to conduct text generation so as to generate audio text data. Thus, it is possible to take measures to easily determine a keyword that needs to be listened to again later, during recording in real time. After a conference is finished, an accurate word is often forgotten although the word is vaguely remembered. In this way, the timing for careful search is easy-to-understand during search later. This may be what is called candidate timing, and in this timing, there is a high possibility that a discussion is under way by using an important keyword, synonyms, and words having a similar nuance. Therefore, because visualizing audio data preferentially at this timing as a text is useful to understand the full discussion, the text-generation control circuit 293 causes text generation to be conducted so as to generate audio text data. Furthermore, at Step S108, the index adding circuit 301 does not always need to generate text, but may only record candidate timing that is intensive search timing, such as x minutes y seconds after the start of recording, by being related to audio data. For metadata to generate audio files, there is a method of recording candidate timing information. After Step S108, the process proceeds to Step S109 described later.

At Step S109, the audio-source position estimating circuit 295 estimates the positions of the audio sources on the basis of the audio data produced by each of the first microphone 20 and the second microphone 21. After Step S109, the process proceeds to Step S110 described later.

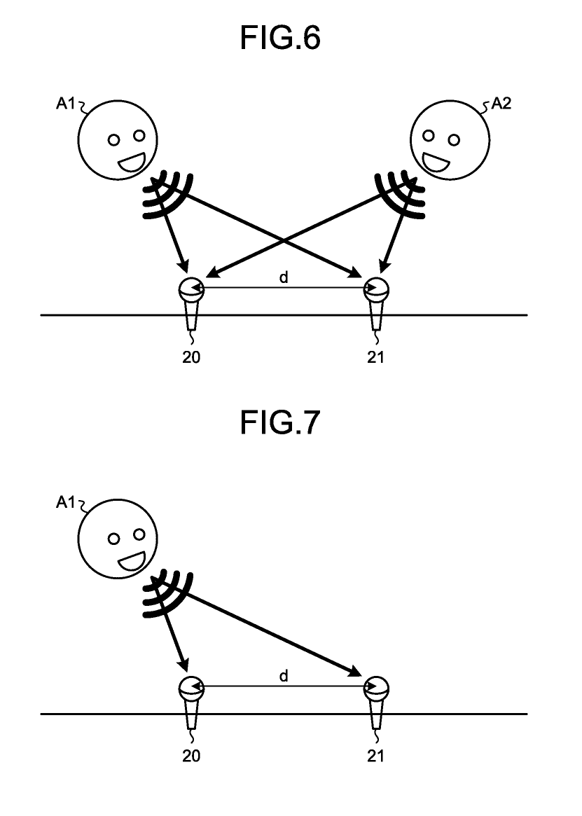

FIG. 6 is a diagram that schematically illustrates the positions of the audio sources estimated by the audio-source position estimating circuit 295. As illustrated in FIG. 6, the audio-source position estimating circuit 295 calculates a difference in arrival times at which voices produced by a speaker who is an audio source Al and a speaker who is an audio source A2 arrive at each of the first microphone 20 and the second microphone 21 on the basis of the audio data generated by each of the first microphone 20 and the second microphone 21 and specifies the focus of the audio sources by using the calculated arrival time difference to estimate an audio source direction.

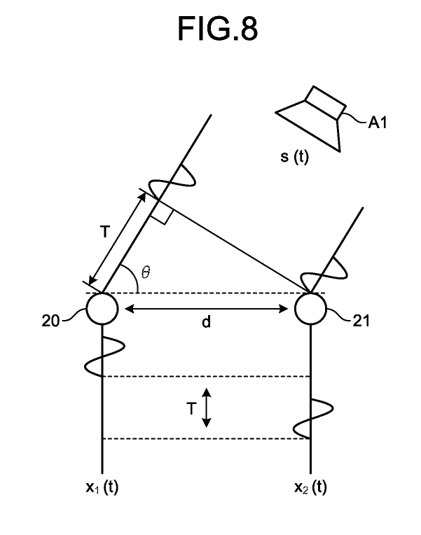

FIG. 7 is a diagram that schematically illustrates a calculation situation where the audio-source position estimating circuit 295 calculates an arrival time difference with respect to a single audio source. FIG. 8 is a diagram that schematically illustrates an example of a calculation method for calculating an arrival time difference, calculated by the audio-source position estimating circuit 295.

As illustrated in FIGS. 7 and 8, the audio-source position estimating circuit 295 calculates an arrival time difference T by using the following Equation (1) where the distance between the first microphone 20 and the second microphone 21 is d, the audio-source orientation of the speaker who is the audio source A1 is ƒ, and the sound velocity is V.

T=(d×COS (θ))/V (1)

In this case, the audio-source position estimating circuit 295 is capable of calculating the arrival time difference T by using the degree of matching between frequencies included in two pieces of audio data generated by the first microphone 20 and the second microphone 21, respectively. Therefore, the audio-source position estimating circuit 295 calculates the arrival time difference T by using the degree of matching between frequencies included in two pieces of audio data generated by the first microphone 20 and the second microphone 21, respectively. Then, the audio-source position estimating circuit 295 estimates the orientation of the audio source by calculating the audio-source orientation θ by using the arrival time difference T and Equation (1). Specifically, the audio-source position estimating circuit 295 uses the following Equation (2) to calculate the audio-source orientation θ, thereby estimating the orientation of the audio source Al.

θ=COS⁻¹ (T×V)/d (2)

In this way, the audio-source position estimating circuit 295 is capable of estimating the orientation of each audio source.

With reference back to FIG. 3, explanation is continuously given of steps subsequent to Step S110.

At Step S110, the information acquiring apparatus 2 performs each audio-source position display determination process to determine the position for displaying audio-source positional information regarding the position of each of the audio sources on the display area of the display 23 in accordance with an estimation result by the audio-source position estimating circuit 295.

Each Audio-Source Position Display Determination Process

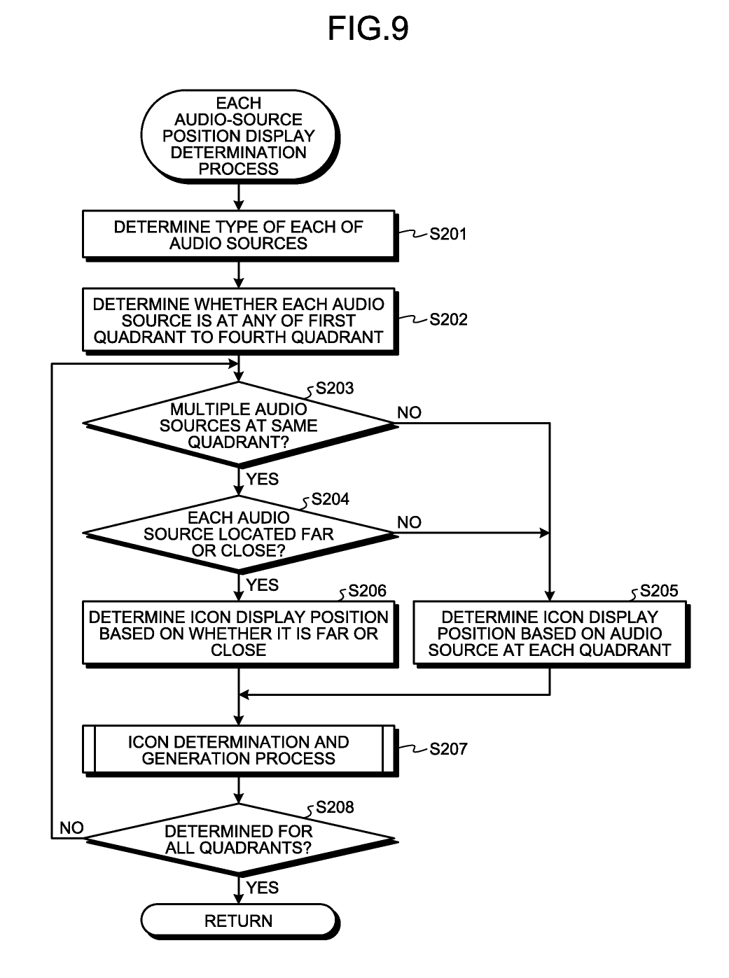

FIG. 9 is a flowchart that illustrates the outline of each audio-source position display determination process at Step S110 of FIG. 3.

As illustrated in FIG. 9, the voice-spectrogram determining circuit 297 determines the type of each of the audio sources on the basis of audio data (Step S201). Specifically, the voice-spectrogram determining circuit 297 uses a known voice-spectrogram authentication technology to analyze the sound produced by the audio sources, estimated by the audio-source position estimating circuit 295, based on the audio data, separates the sound into sounds that correspond to the audio sources, and determines the type of each of the audio sources. For example, the voice-spectrogram determining circuit 297 determines the voice spectrogram (speaker) with respect to each of the audio sources included in audio data on the basis of the speaker identifying template that registers characteristics based on voices produced by speakers who are participating in a conference.

The display-position determining circuit 296 determines whether each of the audio sources on the display area of the display 23 is positioned at any of the first quadrant to the fourth quadrant on the basis of the shape of the display area of the display 23 and the position of each of the audio sources estimated by the audio-source position estimating circuit 295 (Step S202). Specifically, the display-position determining circuit 296 determines the display position of each of the audio sources when the center of the display area of the display 23 is regarded as the information acquiring apparatus 2. For example, the display-position determining circuit 296 determines whether each of the audio sources estimated by the audio-source position estimating circuit 295 is positioned at any of the first quadrant to the fourth quadrant. In this case, the display-position determining circuit 296 divides the display area of the display 23 into four quadrants, the first quadrant to the fourth quadrant, which are partitioned by two straight lines that pass the center of the display area of the display 23 and that are perpendicular to each other on a plane. According to the present embodiment, the display-position determining circuit 296 divides the display area of the display 23 into four quadrants; however, this is not a limitation, and the display area of the display 23 may be divided into two quadrants, or may be optionally divided in accordance with the number of microphones provided in the information acquiring apparatus 2.

Then, the display-position determining circuit 296 determines whether there are multiple audio sources at the same quadrant (Step S203). When the display-position determining circuit 296 determines that there are multiple audio sources at the same quadrant (Step S203: Yes), the process proceeds to Step S204 described later. Conversely, when the display-position determining circuit 296 determines that there are not multiple audio sources at the same quadrant (Step S203: No), the process proceeds to Step S205 described later.

At Step S204, the display-position determining circuit 296 determines whether the audio sources positioned at the same quadrant are located far or close. When the display-position determining circuit 296 determines that the audio sources positioned at the same quadrant are located far or close (Step S204: Yes), the process proceeds to Step S206 described later. Conversely, when the display-position determining circuit 296 determines that the audio sources positioned at the same quadrant are not located far or close (Step S204: No), the process proceeds to Step S205 described later.

At Step S205, the display-position determining circuit 296 determines the display position for displaying an icon on the basis of an audio source at each quadrant. After Step S205, the process proceeds to Step S207 described later.

At Step S206, the display-position determining circuit 296 determines the display position for displaying an icon based on whether each of the audio sources, positioned at the same quadrant, is located far or close. After Step S206, the process proceeds to Step S207 described later.

Icon determination and generation process

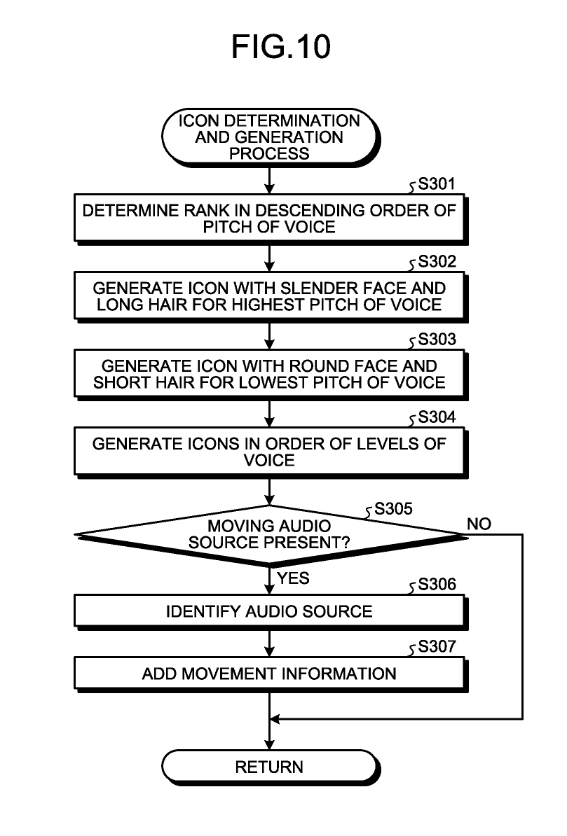

FIG. 10 is a flowchart that illustrates the outline of an icon determination and generation process at Step S207 of FIG. 9.

As illustrated in FIG. 10, the audio-source information generating circuit 298 first ranks the voice spectrograms determined by the voice-spectrogram determining circuit 297 in descending order of a pitch of voice (Step S301).

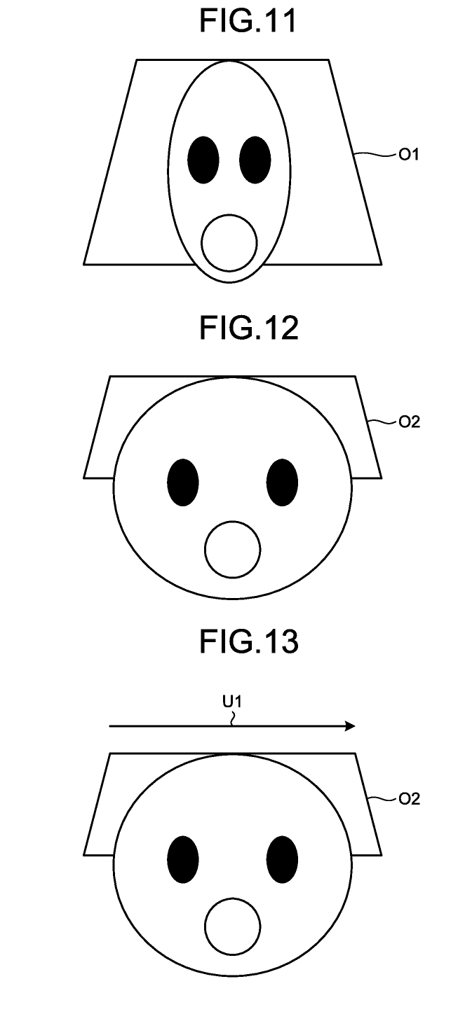

Then, the audio-source information generating circuit 298 generates an icon with a slender face and a long hair for the speaker (audio source) with the highest pitch of voice among the voice spectrograms determined by the voice-spectrogram determining circuit 297 (Step S302). Specifically, as illustrated in FIG. 11, the audio-source information generating circuit 298 generates an icon O1 with a slender face and a long hair (an icon with the image of a woman) for the speaker (audio source) with the highest pitch of voice among the voice spectrograms determined by the voice-spectrogram determining circuit 297.

Then, the audio-source information generating circuit 298 generates an icon with a round face and a short hair for the speaker (audio source) with the lowest pitch of voice among the voice spectrograms determined by the voice-spectrogram determining circuit 297 (Step S303). Specifically, as illustrated in FIG. 12, the audio-source information generating circuit 298 generates an icon O2 with a round face and a short hair (an icon with the image of a man) for the speaker (audio source) with the lowest pitch of voice among the voice spectrograms determined by the voice-spectrogram determining circuit 297.

Then, the audio-source information generating circuit 298 generates icons in order of the levels of voice spectrograms determined by the voice-spectrogram determining circuit 297 (Step S304). Specifically, the audio-source information generating circuit 298 generates icons by sequentially deforming the shape of a face from a slender face to a round face in order of the levels of voice spectrograms determined by the voice-spectrogram determining circuit 297 and sequentially deforming a hair from a long hair to a short hair. Although a business setting is assumed here, a conference is sometimes attended by children; therefore, the audio-source information generating circuit 298 uses a different icon generation method when there are characteristics of children's voices. For example, the audio-source information generating circuit 298 may have an application to improve distinguishability, e.g., when a child is together with an adult, such a situation is determined based on a difference in the quality of voice so that a small icon is generated for the child, or when children are the majority, adults are represented to be larger. As children are in the process of growing, the typical aspect ratio of face is close to 1:1, as compared to that of adults; therefore, it is possible to take measures to enhance and widen the horizontal width of icons. That is, for icon generation, the audio-source information generating circuit 298 may generate icons with its horizontal width enhanced.

Then, the movement determining circuit 300 determines whether the voice spectrograms determined by the voice-spectrogram determining circuit 297 include a moving audio source that is moving through two or more quadrants of the first quadrant to the fourth quadrant on the basis of the position of each of the audio sources estimated by the audio-source position estimating circuit 295 and the voice spectrograms determined by the voice-spectrogram determining circuit 297 (Step S305). Specifically, the movement determining circuit 300 determines whether an audio source in each quadrant determined by the display-position determining circuit 296 and the position of each audio source estimated by the audio-source position estimating circuit 295 are different as time passes and, when they are different with time, it is determined that there is a moving audio source. When the movement determining circuit 300 determines that there is an audio source moving through each quadrant (Step S305: Yes), the process proceeds to Step S306 described later. Conversely, when the movement determining circuit 300 determines that there is no audio source moving through each quadrant (Step S305: No), the information acquiring apparatus 2 returns to the subroutine of FIG. 9 described above.

At Step S306, the audio identifying circuit 299 identifies the icon that corresponds to the audio source determined by the movement determining circuit 300. Specifically, the audio identifying circuit 299 identifies the icon of an audio source that is moving through two or more quadrants of the first quadrant to the fourth quadrant, determined by the movement determining circuit 300.

Then, the audio-source information generating circuit 298 adds movement information to the icon of the audio source identified by the audio identifying circuit 299 (Step S307). Specifically, as illustrated in FIG. 13, the audio-source information generating circuit 298 adds a movement icon U1 (movement information) to the icon O2 of the audio source identified by the audio identifying circuit 299. Here, the audio-source information generating circuit 298 adds the movement icon U1 to the icon O2 that has moved; however, for example, the color of the icon O2 may be changed, or the shape thereof may be changed. The audio-source information generating circuit 298 may add a text or a graphic to the icon O2 that has moved or may add a moving time period, moving timing, or the like. After Step S307, the information acquiring apparatus 2 returns to the subroutine of FIG. 9 described above.

With reference back to FIG. 9, explanation is continued for a step subsequent to Step S208.

At Step S208, when determination for all the quadrants has been finished (Step S208: Yes), the information acquiring apparatus 2 returns to the main routine of FIG. 3. Conversely, when determination for all the quadrants has not been finished (Step S208: No), the information acquiring apparatus 2 returns to Step S203 described above.

With reference back to FIG. 3, explanation is continued for a step subsequent to Step S111.

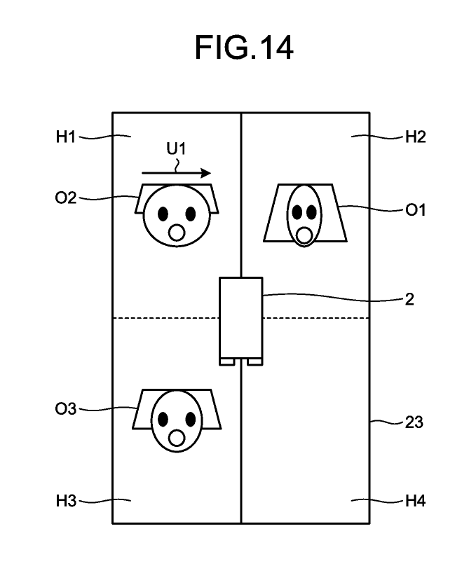

At Step S111, the display control circuit 303 causes the display 23 to display multiple pieces of audio-source positional information generated at Step S110 described above. Specifically, as illustrated in FIG. 14, the display control circuit 303 causes the display 23 to display the icon O1 to an icon O3 on a first quadrant H1 to a third quadrant H3 of the display area of the display 23, respectively. This allows a user to intuitively understand the position of the speaker (audio source) when the information acquiring apparatus 2 is regarded as a center even during recording. Furthermore, superimposition of the movement icon U1 on the icon O2 allows a user to intuitively understand the speaker who has moved during recording.

At Step S112, when a command signal to terminate recording has been input from the input unit 25 (Step S112: Yes), the process proceeds to Step S113 described later. Conversely, when a command signal to terminate recording has not been input from the input unit 25 (Step S112: No), the information acquiring apparatus 2 returns to Step S103 described above.

At Step S113, an audio file is generated, which relates audio data on which the signal processing circuit 291 has conducted signal processing, audio-source positional information estimated by the audio-source position estimating circuit 295, multiple pieces of audio source information generated by the audio-source information generating circuit 298, an appearance position identified by the audio identifying circuit 299, positional information about the position of an index added by the index adding circuit 301 or time information about the time of the index added in the audio data, and audio text data generated by the text generating circuit 292, and is stored in the audio file memory 262. After Step S113, the process proceeds to Step S114 described later. Here, the audio-file generating circuit 302 may generate an audio file that relates audio data on which the signal processing circuit 291 has conducted signal processing and candidate timing information that defines candidate timing for the text generating circuit 292 to generate audio text data during a predetermined time period after the input unit 25 receives input of a command signal, and store the audio file in the audio file memory 262. That is, the audio-file generating circuit 302 may generate an audio file that relates audio data and candidate timing information that defines candidate timing during a predetermined time period after the input unit 25 receives input of a command signal and store the audio file in the audio file memory 262.

Then, when a command signal to turn off the power has been input from the input unit 25 (Step S114: Yes), the information acquiring apparatus 2 terminates this process. Conversely, when a command signal to turn off the power has not been input from the input unit 25 (Step S114: No), the information acquiring apparatus 2 returns to Step S101 described above.

At Step S101, when a command signal to give a command for recording has not been input from the input unit 25 (Step S101: No), the process proceeds to Step S115.

Then, when a command signal to give a command so as to reproduce an audio file has been input from the input unit 25 (Step S115: Yes), the process proceeds to Step S116 described later. Conversely, when a command signal to give a command so as to reproduce an audio file has not been input from the input unit 25 (Step S115: No), the process proceeds to Step S122.

At Step S116, when the input unit 25 has been operated to select an audio file (Step S116: Yes), the process proceeds to Step S117 described later. Conversely, when the input unit 25 has not been operated and therefore no audio file has been selected (Step S116: No), the process proceeds to Step S114.

At Step S117, the display control circuit 303 causes the display 23 to display multiple pieces of audio-source positional information contained in the audio file selected via the input unit 25.

Then, when any of the icons of the pieces of audio-source positional information displayed on the display 23 has been touched via the touch panel 251 (Step S118: Yes), the output circuit 28 reproduces and outputs the audio data that corresponds to the icon (Step S119).

Then, when a command signal to terminate reproduction of the audio file has been input from the input unit 25 (Step S120: Yes), the process proceeds to Step S114. Conversely, when a command signal to terminate reproduction of the audio file has not been input from the input unit 25 (Step S120: No), the information acquiring apparatus 2 returns to Step S117 described above.

At Step S118, when either of the icons of the pieces of audio-source positional information diaplayed on the display 23 has not been touched via the touch panel 251 (Step S118: No), the output circuit 28 reproduces the audio data (Step S121). After Step S121, the process proceeds to Step S120.

At Step S122, when a command signal to transmit the audio file has been input due to an operation on the input unit 25 (Step S122: Yes), the communication circuit 27 transmits the audio file to the information processing apparatus 3 in accordance with a predetermined communication standard (Step S123). After Step S123, the process proceeds to Step S114.

At Step S122, when a command signal to transmit the audio file has not been input due to an operation on the input unit 25 (Step S122: No), the process proceeds to Step S114.

Process of the Information Processing Apparatus

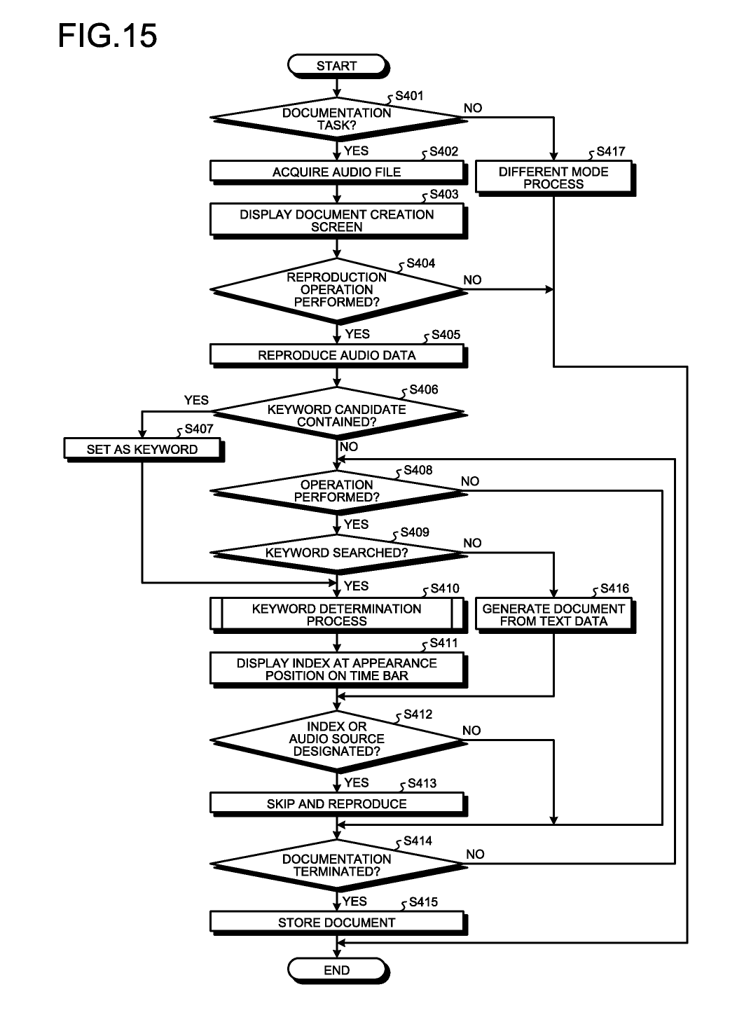

Next, a process performed by the information processing apparatus 3 is explained. FIG. 15 is a flowchart that illustrates the outline of a process performed by the information processing apparatus 3.

As illustrated in FIG. 15, first, when a user is to perform a documentation task to create a summary while audio data is reproduced (Step S401: Yes), the communication circuit 31 acquires the audio file from the information acquiring apparatus 2 connected to the information processing apparatus 3 (Step S402).

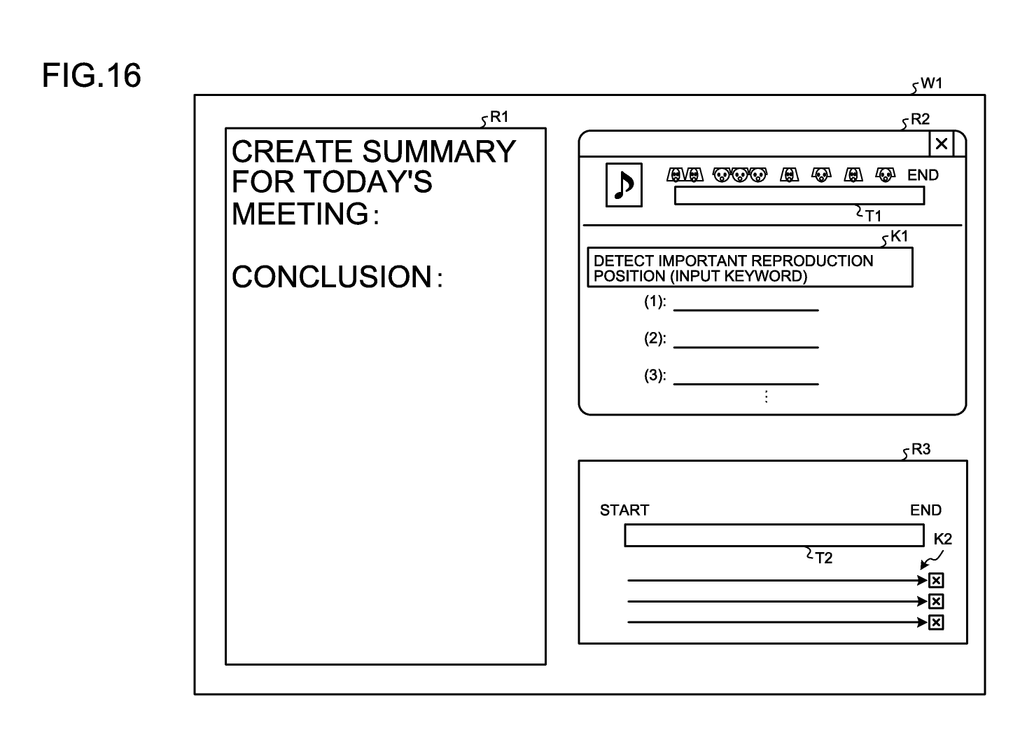

Then, the display control circuit 366 causes the display 35 to display a document creation screen (Step S403). Specifically, as illustrated in FIG. 16, the display control circuit 366 causes the display 35 to display a document creation screen W1. The document creation screen W1 includes a display area R1, a display area R2, and a display area R3. The display area R1 displays texts that correspond to text data that is transcribed from reproduced audio data due to user's operation on the input unit 32. The display area R2 includes: a time bar Ti that corresponds to audio data contained in an audio file; a display area K1 that displays a keyword that is input in accordance with an operation on the input unit 32; and the icons O1 to O3 representing audio source information about audio sources during recording. The display area R3 includes: a time bar T2 that corresponds to audio data contained in an audio file; and a display area K2 that displays the appearance position of a keyword.

Then, when a reproduction operation to reproduce audio data has been performed via the input unit 32 (Step S404: Yes), the audio control circuit 365 causes the speaker 34 to reproduce the audio data contained in the audio file (Step S405).

Then, the keyword determining circuit 363 determines whether the audio file contains a keyword candidate (Step S406). Specifically, the keyword determining circuit 363 determines whether the audio file contains one or more pieces of audio text data as keywords. When the keyword determining circuit 363 determines that the audio file contains a keyword candidate (Step S406: Yes), the keyword setting circuit 364 sets the keyword candidate contained in the audio file as a keyword for searching for an appearance position in the audio data (Step S407). Specifically, the keyword setting circuit 364 sets one or more pieces of audio text data contained in an audio file as a keyword for searching for an appearance position in the audio data. After Step S407, the information processing apparatus 3 proceeds to Step S410 described later. Conversely, when the keyword determining circuit 363 determines that the audio file contains no keyword candidate (Step S406: No), the information processing apparatus 3 proceeds to Step S408 described later. After a conference is finished, an accurate word is often forgotten although a word, which is a keyword, is vaguely remembered; therefore, the keyword determining circuit 363 may search for synonyms by using a dictionary, or the like, which records words having a similar meaning.

At Step S408, when the input unit 32 has been operated (Step S408: Yes) and when a specific keyword appearing in audio data is to be searched for via the input unit 32 (Step S409: Yes), the information processing apparatus 3 proceeds to Step S410 described later. Conversely, when the input unit 32 has been operated (Step S408: Yes) and when a specific keyword appearing in audio data is not to be searched for via the input unit 32 (Step S409: No), the information processing apparatus 3 proceeds to Step S416 described later.

At Step S408, when the input unit 32 has not been operated (Step S408: No), the information processing apparatus 3 proceeds to Step S414 described later.

At Step S410, the information-processing control circuit 36 performs a keyword determination process to determine the time when a keyword appears in audio data.

Keyword Determination Process

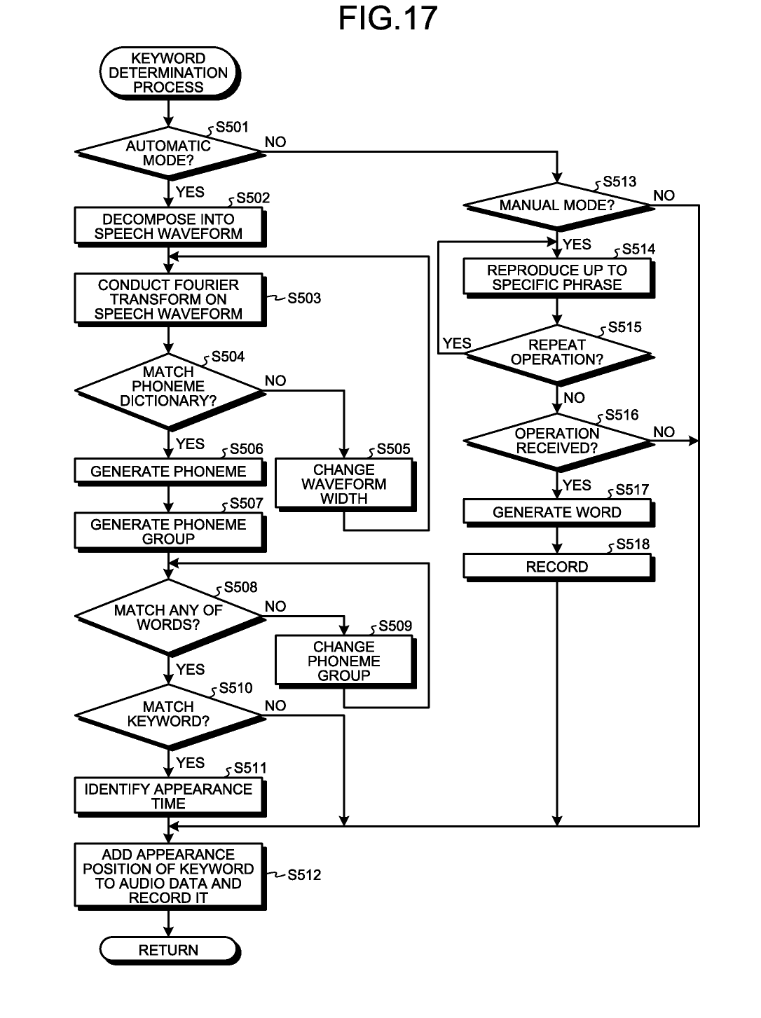

FIG. 17 is a flowchart that illustrates the outline of the keyword determination process at Step S410 of FIG. 15 described above.

As illustrated in FIG. 17, when an automatic mode is set to automatically detect a specific keyword appearing in audio data (Step S501: Yes), the information processing apparatus 3 proceeds to Step S502 described later. Conversely, when an automatic mode to automatically detect a specific keyword appearing in audio data is not set (Step S501: No), the information processing apparatus 3 proceeds to Step S513 described later.

At Step S502, the text generating circuit 361 decomposes audio data into a speech waveform (Step S502) and conducts Fourier transform on the decomposed speech waveform to generate audio text data (Step S503).

Then, the keyword determining circuit 363 determines whether the audio text data, on which the text generating circuit 361 has conducted Fourier transform, matches any of phonemes included in the phoneme dictionary data recorded in the audio-to-text dictionary data memory 332 (Step S504). Specifically, the keyword determining circuit 363 determines whether the result of Fourier transform conducted by the text generating circuit 361 matches the waveform of any of the phonemes included in the phoneme dictionary data recorded in the audio-to-text dictionary data memory 332. However, as individuals have a habit or a difference in pronunciations, the keyword determining circuit 363 does not need to determine a perfect match but may make a determination as to whether there is a high degree of similarity. Furthermore, as some people say the same thing in different ways, search may be conducted by using synonyms if needed. When the keyword determining circuit 363 determines that the result of Fourier transform conducted by the text generating circuit 361 matches (has a high degree of similarity with) any of the phonemes included in the phoneme dictionary data recorded in the audio-to-text dictionary data memory 332 (Step S504: Yes), the information processing apparatus 3 proceeds to Step S506 described later. Conversely, when the keyword determining circuit 363 determines that the result of Fourier transform conducted by the text generating circuit 361 does not match (has a low degree of similarity with) any of the phonemes included in the phoneme dictionary data recorded in the audio-to-text dictionary data memory 332 (Step S504: No), the information processing apparatus 3 proceeds to Step S505 described later.

At Step S505, the text generating circuit 361 changes the waveform width for conducting Fourier transform on the decomposed speech waveform. After Step S505, the information processing apparatus 3 returns to Step S503.

At Step S506, the text generating circuit 361 generates a phoneme as a result of Fourier transform from the phoneme that has a match as determined by the keyword determining circuit 363.

Then, the text generating circuit 361 generates a phoneme group that is made up of phonemes (Step S507).

Then, the keyword determining circuit 363 determines whether the phoneme group generated by the text generating circuit 361 matches (has a high degree of similarity with) any of words included in audio-to-text dictionary data recorded in the audio-to-text dictionary data memory 332 (Step S508). When the keyword determining circuit 363 determines that the phoneme group generated by the text generating circuit 361 matches (has a high degree of similarity with) any of words included in audio-to-text dictionary data recorded in the audio-to-text dictionary data memory 332 (Step S508: Yes), the information processing apparatus 3 proceeds to Step S510 described later. Conversely, when the keyword determining circuit 363 determines that the phoneme group generated by the text generating circuit 361 does not match (has a low degree of similarity with) any of words included in audio-to-text dictionary data recorded in the audio-to-text dictionary data memory 332 (Step S508: No), the information processing apparatus 3 proceeds to Step S509 described later.

At Step S509, the text generating circuit 361 changes a phoneme group that is made up of phonemes. For example, the text generating circuit 361 decreases or increases the number of phonemes to change a phoneme group. After Step S509, the information processing apparatus 3 returns to Step S508 described above. An example of the process including each operation at Step S502 to Step S509 corresponds to the above-described sound recognition processing.

At Step S510, the identifying circuit 362 determines whether the character string of a keyword input via the input unit 32 matches (has a high degree of similarity with) the character string in audio text data generated by the text generating circuit 361. In this case, the identifying circuit 362 may determine whether the character string of a keyword set by the keyword setting circuit 364 matches (has a high degree of similarity with) the character string in audio text data generated by the text generating circuit 361. When the identifying circuit 362 determines that the character string of a keyword input via the input unit 32 matches (has a high degree of similarity with) the character string in audio text data generated by the text generating circuit 361 (Step S510: Yes), the information processing apparatus 3 proceeds to Step S511 described later. Conversely, when the identifying circuit 362 determines that the character string of a keyword input via the input unit 32 does not match (has a low degree of similarity with) the character string in audio text data generated by the text generating circuit 361 (Step S510: No), the information processing apparatus 3 proceeds to Step S512 described later.

At Step S511, the identifying circuit 362 identifies the appearance time of the keyword in audio data. Specifically, the identifying circuit 362 identifies the time period during which the character string of the keyword input via the input unit 32 matches (has a high degree of similarity with) the character string in the audio text data generated by the text generating circuit 361 as the appearance position (appearance time) of the keyword in the audio data. However, as individuals have a habit or a difference in pronunciations, the identifying circuit 362 does not need to determine a perfect match but may make a determination as to whether there is a high degree of similarity. Furthermore, as some people say the same thing in different ways, the identifying circuit 362 may conduct search by using synonyms if needed. Thus, it is possible to take measures to easily determine a keyword that needs to be listened to again later during reproduction in real time. After reproduction data is finished, an accurate word is often forgotten although the word is vaguely remembered. In this way, the timing for careful search is easy-to-understand during search later. This may be what is called candidate timing, and in this timing, there is a high possibility that a discussion is under way by using an important keyword, synonyms, and words having a similar nuance. Therefore, as visualizing audio data at this timing as a text preferentially is useful to understand the full discussion, the identifying circuit 362 may cause the text generating circuit 361 to conduct text generation to generate audio text data. Furthermore, at Step S511, the identifying circuit 362 does not always need to generate texts but may only record candidate timing that is intensive search timing, such as timing in x minutes y seconds after the start of recording, by being related to audio data. For metadata to generate audio files, there is a method of recording candidate timing information.

Then, the document generating circuit 367 adds and the records the appearance position of the keyword identified by the identifying circuit 362 to the audio data (Step S512). After Step S512, the information processing apparatus 3 returns to the main routine of FIG. 15 described above.

At Step S513, when a manual mode is set, during which a user manually detects a specific keyword appearing in audio data (Step S513: Yes), the speaker 34 reproduces the audio data up to a specific phrase (Step S514).

Then, when a command signal to give a command for a repeat operation up to a specific frame has been input from the input unit 32 (Step S515: Yes), the information processing apparatus 3 returns to Step S514 described above. Conversely, when a command signal to give a command for a repeat operation up to a specific frame has not been input from the input unit 32 (Step S515: No), the information processing apparatus 3 proceeds to Step S516 described later.

At Step S513, when a manual mode is not set, during which a user manually detects a specific keyword appearing in audio data (Step S513: No), the information processing apparatus 3 proceeds to Step S512.

At Step S516, when an operation to input a keyword has been received via the input unit 32 (Step S516: Yes), the text generating circuit 361 generates a word from the keyword in accordance with the operation on the input unit (Step S517).

Then, the document generating circuit 367 adds an index to the audio data at the time when the keyword is input via the input unit 32 and records the index (Step S518). After Step S518, the information processing apparatus 3 proceeds to Step S512.

At Step S516, when an operation to input a keyword has not been received via the input unit 32 (Step S516: No), the information processing apparatus 3 proceeds to Step S512.

With reference back to FIG. 15, an explanation is given of a step subsequent to Step S411.

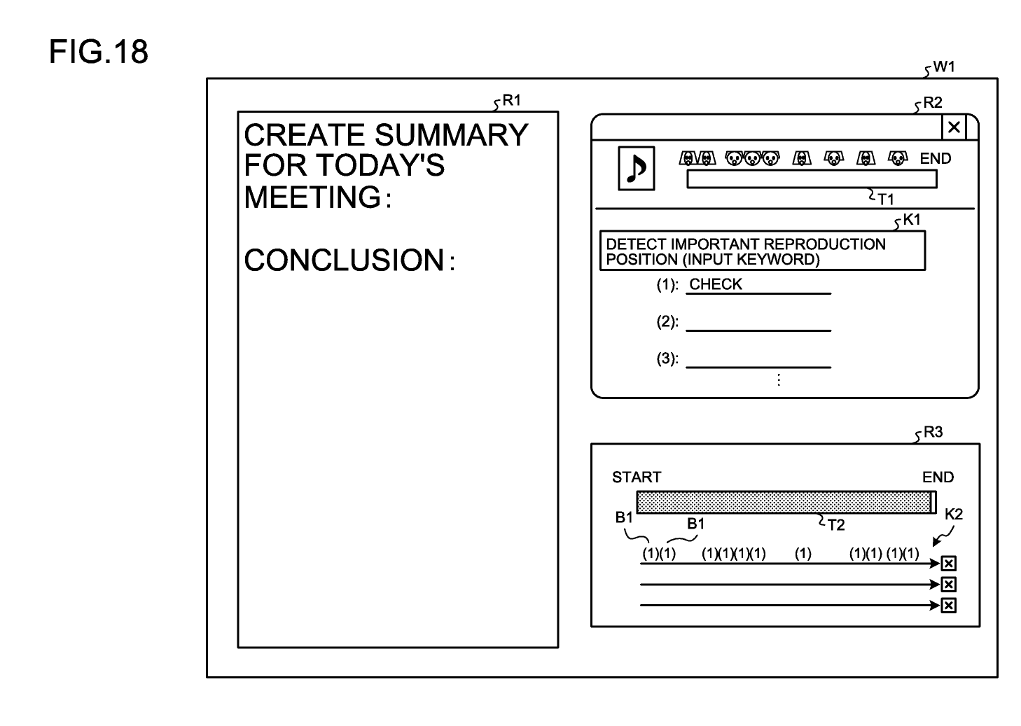

At Step S411, the display control circuit 366 adds an index to the appearance position of the appearing keyword, identified by the identifying circuit 362, on the time bar displayed by the display 35 and causes the display 35 to display the index. Specifically, as illustrated in FIG. 18, the display control circuit 366 adds an index B1 to the appearance position of the appearing keyword, e.g., “check”, identified by the identifying circuit 362, on the time bar T2 displayed by the display 35 and causes the display 35 to display the index B1. More specifically, the display control circuit 366 adds (1), which is the index B1, to the appearance position of the appearing keyword, e.g., “check”, identified by the identifying circuit 362, in the neighborhood of the time bar T2 displayed by the display 35 and causes the display 35 to display (1), which is the index B1. This allows a user to intuitively know the appearance position of a desired keyword. Incidentally the display control circuit 366 may superimpose (1), which is the index B1, at the appearance position of the appearing keyword identified by the identifying circuit 362 on the time bar T2 displayed by the display 35 and cause the display 35 to display (1), which is the index B1. Alternatively, a graphic or text data may be superimposed as the index B1, or an appearance position may be indicated on or near the time bar T2 by color that is distinguishable from that of other regions. The display control circuit 366 may cause the display 35 to display the time of the appearance position of the appearing keyword identified by the identifying circuit 362.

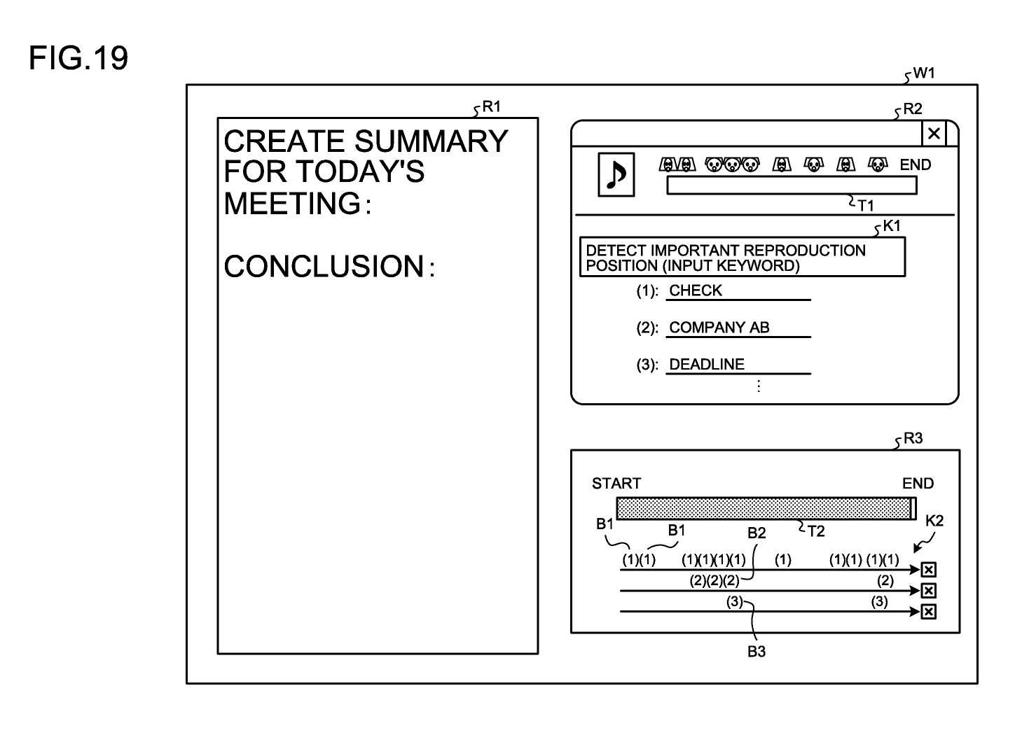

Furthermore, as illustrated in FIG. 19, when a user has set three keywords, for example, “check”, “company AB”, and “deadline”, the display control circuit 366 adds (1), (2), and (3), which are the index B1, an index B2, and an index B3, to the appearance positions of the three appearing keywords identified by the identifying circuit 362 on the time bar T2 displayed by the display 35 and causes the display 35 to display the indices. In this case, the display control circuit 366 may add an additional index to the appearance position where all the three keywords identified by the identifying circuit 362 appear within a predetermined time period (e.g., within 10 seconds or more) on the time bar T2 displayed by the display 35 and cause the display 35 to display the additional index. Here, the display control circuit 366 may add an index to the appearance position where a first keyword appears on the time bar T2 and cause the display 35 to display the index. This allows a user to intuitively know the appearance position where desired keywords appear in audio data.

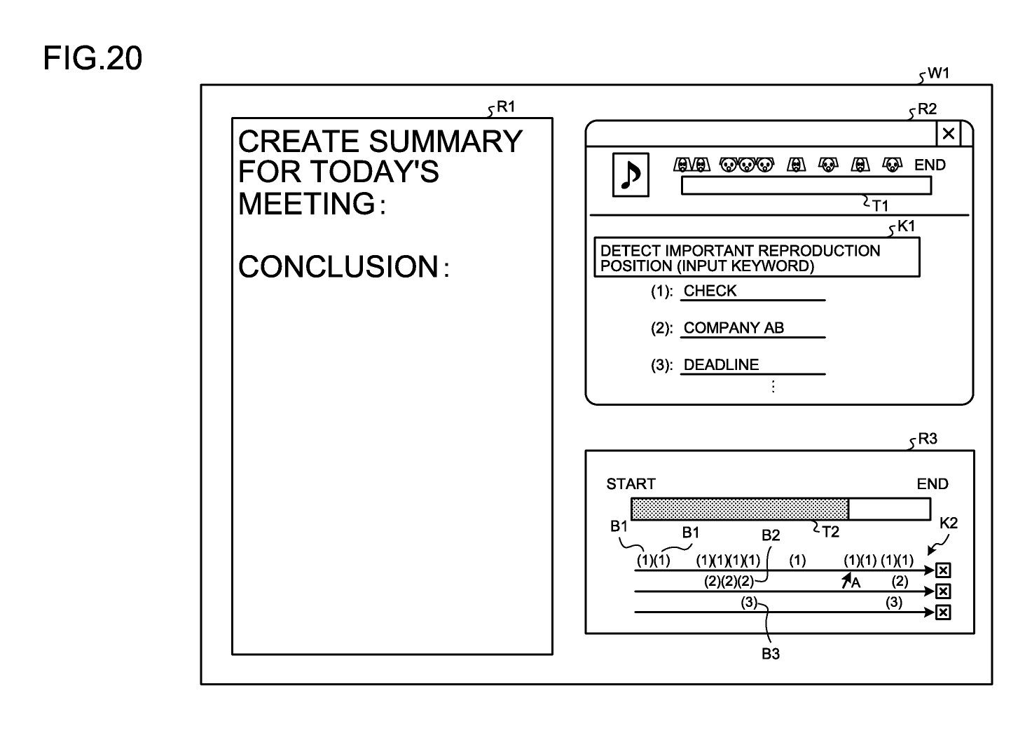

Then, when any of the indexes on the time bar or the audio sources (icons) has been designated via the input unit 32 (Step S412: Yes), the audio control circuit 365 skips the audio data to the time that corresponds to the index on the time bar, designated via the input unit 32, or the time chart that corresponds to the designated audio source and causes the speaker 34 to reproduce the audio data therefrom (Step S413). Specifically, as illustrated in FIG. 20, when a user designates the index (1) with the arrow A via the input unit 32, the audio control circuit 365 skips the audio data to the time that corresponds to the index on the time bar T2, designated via the input unit 32, and causes the speaker 34 to reproduce the audio data therefrom. This allows a user to intuitively know the appearance position of a desired keyword and to produce transcription at a desired position.

Then, when an operation to terminate documentation has been performed via the input unit 32 (Step S414: Yes), the document generating circuit 367 generates a document file that relates the document input by a user via the input unit 32, the audio data, and the appearance position identified by the identifying circuit 362 and stores the document file in the memory 33 (Step S415). After Step S415, the information processing apparatus 3 terminates this process. Conversely, when an operation to terminate documentation has not been performed via the input unit 32 (Step S414: No), the information processing apparatus 3 returns to Step S408 described above.

At Step S412, an index on the time bar has not been designated via the input unit 32 (Step S412: No), the information processing apparatus 3 proceeds to Step S414.

At Step S416, the text generating circuit 361 generates a document from the text data in accordance with an operation on the input unit 32. After Step S416, the information processing apparatus 3 proceeds to Step S412.

At Step S404, when a reproduction operation to reproduce audio data has not been performed via the input unit 32 (Step S404: No), the information processing apparatus 3 terminates this process.

At Step S401, when a user is not to perform a documentation task to create a summary while audio data is reproduced (Step S401: No), the information processing apparatus 3 performs a process that corresponds to a different mode process other than the documentation task (Step S417). After Step S417, the information processing apparatus 3 terminates this process.

According to the above-described first embodiment, the display control circuit 303 causes the display 23 to display audio-source positional information about the position of each of the audio sources in accordance with an estimation result estimated by the audio-source position estimating circuit 295, whereby the position of a speaker during recording may be intuitively understood.

Furthermore, according to the first embodiment, the display control circuit 303 causes the display 23 to display audio-source positional information in accordance with a determination result determined by the display-position determining circuit 296, whereby the position of a speaker may be intuitively understood in accordance with the shape of the display 23.

Furthermore, according to the first embodiment, the display-position determining circuit 296 determines the display position of each of the audio sources when the information acquiring apparatus 2 is in the center of the display area of the display 23, whereby the position of a speaker when the information acquiring apparatus 2 is in the center may be intuitively understood.

Furthermore, according to the first embodiment, the display control circuit 303 causes the display 23 to display multiple pieces of audio source information that are generated as audio-source positional information by the audio-source information generating circuit 298, whereby the sex and the number of speakers who have participated during recording may be intuitively understood.

Furthermore, according to the first embodiment, the audio-file generating circuit 302 generates an audio file that relates audio data, audio-source positional information estimated by the audio-source position estimating circuit 295, multiple pieces of audio source information generated by the audio-source information generating circuit 298, an appearance position identified by the audio identifying circuit 299, positional information about the position of an index added by the index adding circuit 301 or time information about a time of an index added in audio data, and audio text data generated by the text generating circuit 292 and stores the audio file in the audio file memory 262, whereby when a summary is created by the information processing apparatus 3, a position desired by a creator may be understood.

Furthermore, according to the first embodiment, the audio-source information generating circuit 298 adds information indicating a movement to audio source information on the audio source that is moving as determined by the movement determining circuit 300, whereby a speaker who has moved during recording may be intuitively understood.

### Second Embodiment

Next, a second embodiment is explained. Here, the same components as those in an information acquiring system 1 according to the first embodiment described above are attached with the same reference numerals, and detailed explanations are omitted as appropriate.

Schematic Configuration of an Information Acquiring System

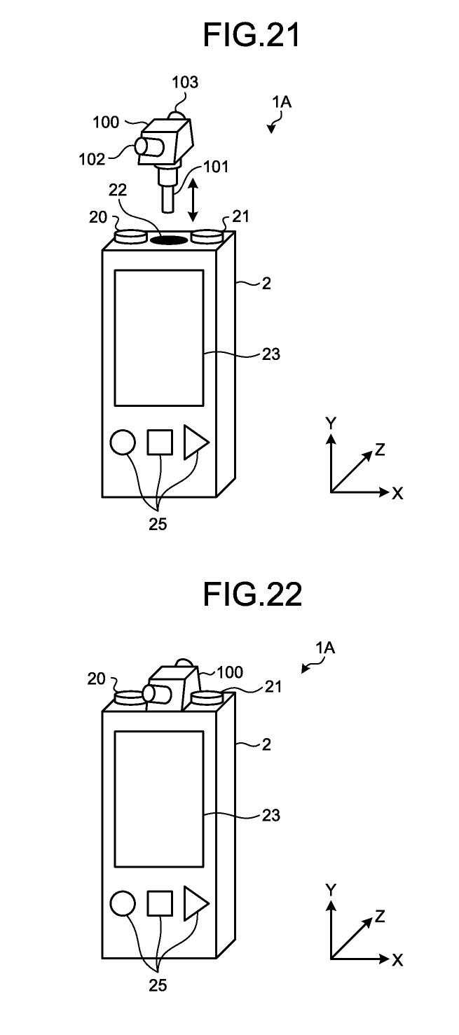

FIGS. 21 and 22 are schematic diagrams that illustrate the schematic configuration of an information acquiring system according to the second embodiment.

An information acquiring system 1A illustrated in FIGS. 21 and 22 includes the information acquiring apparatus 2 according to the above-described first embodiment and an external microphone 100 that is attachable to and detachable from the information acquiring apparatus 2. Furthermore, in the following explanation, the plane on which the information acquiring apparatus 2 is placed in a standing manner is the XZ plane, and the direction perpendicular to the XZ plane is the Y direction.

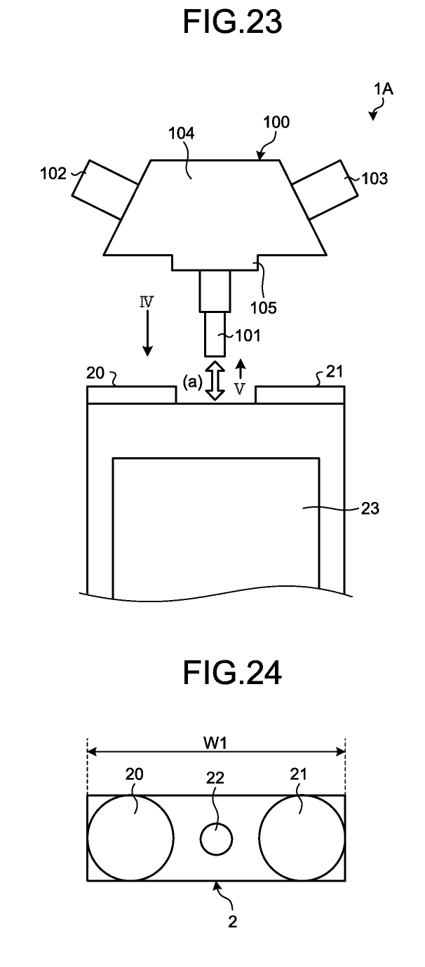

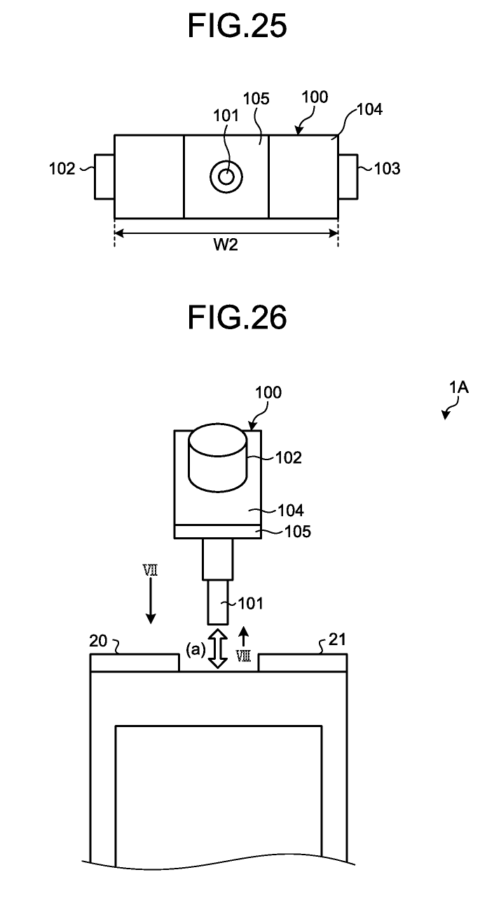

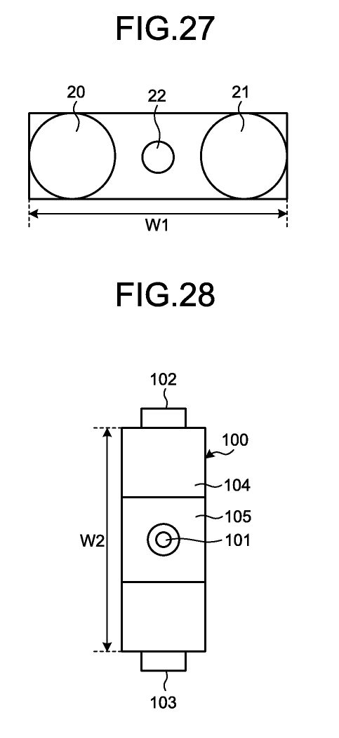

FIG. 23 is a schematic diagram that partially illustrates the relevant part of the information acquiring system 1A. FIG. 24 is a top view of the information acquiring apparatus 2 when viewed in the IV direction of FIG. 23. FIG. 25 is a bottom view of the external microphone 100 when viewed in the V direction of FIG. 23. FIG. 26 is a schematic diagram that partially illustrates the relevant part of the information acquiring system 1A. FIG. 27 is a top view of the information acquiring apparatus 2 when viewed in the VII direction of FIG. 26. FIG. 28 is a bottom view of the external microphone 100 when viewed in the VIII direction of FIG. 26.

Configuration of the External Microphone

The configuration of the external microphone 100 is explained.

As illustrated in FIGS. 21 to 28, the external microphone 100 includes an insertion plug 101, a third microphone 102, a fourth microphone 103, and a main body unit 104.

The insertion plug 101 is provided on the lower surface of the main body unit 104, and inserted into the external-input detecting circuit 22 of the information acquiring apparatus 2 in an attachable and detachable manner.

The third microphone 102 is provided on the side surface of the external microphone 100 on the left side with respect to a longitudinal direction W2 thereof. The third microphone 102 collects sound produced by each of the audio sources and generates audio data. The third microphone 102 has the same configuration as that of the first microphone 20, and is configured by using any single microphone out of a unidirectional microphone, a non-directional microphone, and a bidirectional microphone.

The fourth microphone 103 is provided on the side surface of the external microphone 100 on the right side with respect to the longitudinal direction W2. The fourth microphone 103 collects sound produced by each of the audio sources and generates audio data. The fourth microphone 103 has the same configuration as that of the first microphone 20, and is configured by using any single microphone out of a unidirectional microphone, a non-directional microphone, and a bidirectional microphone.

The main body unit 104 is substantially cuboidal (four-sided pyramid), and provided with the third microphone 102 and the fourth microphone 103 on the right and left on the side surfaces with respect to the longitudinal direction W2. Furthermore, on the lower surface of the main body unit 104, a contact portion 105 is provided which is in contact with the information acquiring apparatus 2 when the insertion plug 101 of the external microphone 100 is inserted into the information acquiring apparatus 2.

Method of Securing the External Microphone

Next, an explanation is given of a method of securing the external microphone 100 to the information acquiring apparatus 2.

Securing method for normal recording First, an explanation is given of a securing method when normal recording is conducted by using the external microphone 100. As illustrated in FIGS. 23 to 25, the insertion plug 101 of the external microphone 100 is inserted into the information acquiring apparatus 2 in a state where the straight line connecting the first microphone 20 and the second microphone 21 is substantially parallel to the longitudinal direction of the external microphone 100. Specifically, the insertion plug 101 of the external microphone 100 is inserted into the information acquiring apparatus 2 in a state (hereafter, simply referred to as parallel state) where the straight line connecting the first microphone 20 and the second microphone 21 is substantially parallel to the straight line connecting the third microphone 102 and the fourth microphone 103.

In this way, when a user performs normal recording by using the external microphone 100, the insertion plug 101 of the external microphone 100 is inserted into the external-input detecting circuit 22 of the information acquiring apparatus 2 such that the external microphone 100 is in a parallel state with respect to the information acquiring apparatus 2. This allows the information acquiring apparatus 2 to conduct normal stereo or monaural recording by using the external microphone 100. The external microphone 100 may be selected from the ones having frequency characteristics different from those of built-in microphones (the first microphone 20 and the second microphone 21) and the ones having desired performances, and may be used in a different way from the first microphone 20 and the second microphone 21, which are built-in microphones, for example, may be placed away from the information acquiring apparatus 2 by using an extension cable or may be attached onto a collar.

Securing method for 360-degree spatial sound recording Next, an explanation is given of a securing method when 360-degree spatial sound recording is conducted by using the external microphone 100. As illustrated in FIGS. 26 to 28, the insertion plug 101 of the external microphone 100 is inserted into the information acquiring apparatus 2 in a state where the straight line connecting the first microphone 20 and the second microphone 21 is substantially perpendicular to the longitudinal direction of the external microphone 100. Specifically, the insertion plug 101 of the external microphone 100 is inserted into the information acquiring apparatus 2 in a state (hereafter, simply referred to as “perpendicular state”) where the straight line connecting the first microphone 20 and the second microphone 21 is substantially perpendicular to the straight line connecting the third microphone 102 and the fourth microphone 103.

In this way, when a user conducts 360-degree spatial sound recording by using the external microphone 100, the insertion plug 101 of the external microphone 100 is inserted into the external-input detecting circuit 22 of the information acquiring apparatus 2 such that the external microphone 100 is in a perpendicular state with respect to the information acquiring apparatus 2. This allows the information acquiring apparatus 2 to conduct 360-degree spatial sound recording by using the external microphone 100 having high general versatility with a simple configuration.

Functional Configuration of the Information Acquiring Apparatus

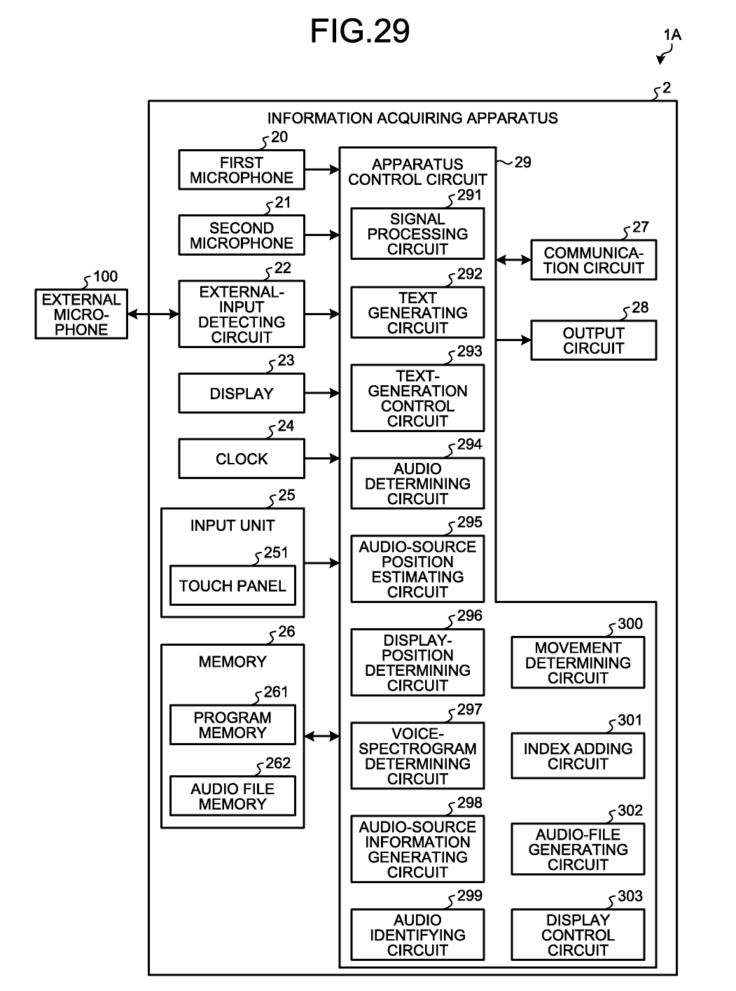

Next, a functional configuration of the above-described information acquiring apparatus 2 is explained. FIG. 29 is a block diagram that illustrates the functional configuration of the information acquiring apparatus 2.

As illustrated in FIG. 29, the information acquiring apparatus 2 includes the first microphone 20, the second microphone 21, the external-input detecting circuit 22, the display 23, the clock 24, the input unit 25, the memory 26, the communication circuit 27, the output circuit 28, and the apparatus control circuit 29.

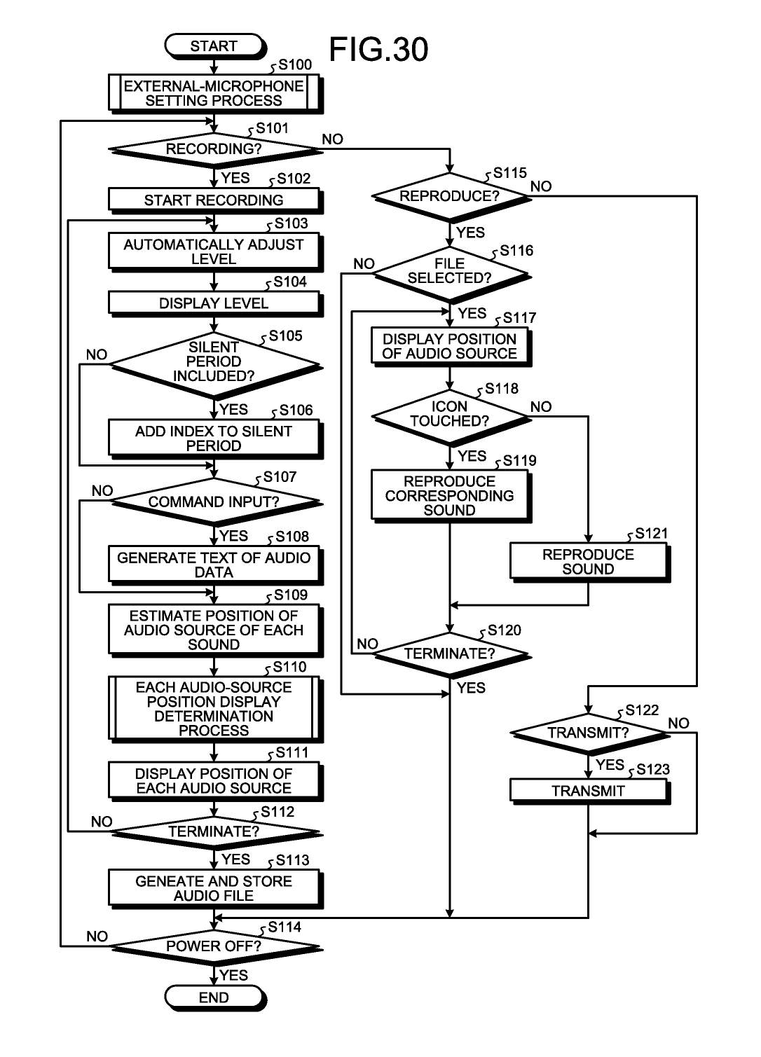

Process of the information acquiring apparatus Next, a process performed by the information acquiring apparatus 2 is explained. FIG. 30 is a flowchart that illustrates the outline of a process performed by the information acquiring apparatus 2.

First, as illustrated in FIG. 30, the information acquiring apparatus 2 performs an external-microphone setting process to set the external microphone 100 (Step S100).

External-Microphone Setting Process

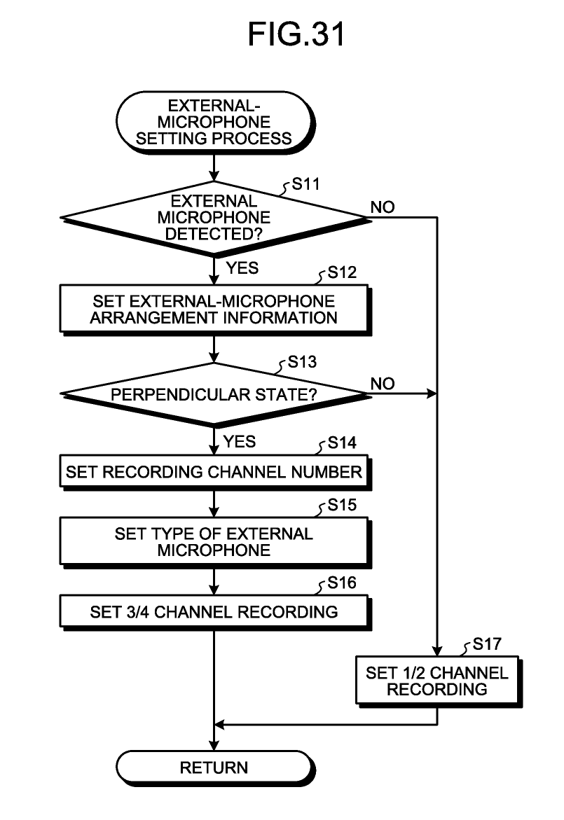

FIG. 31 is a flowchart that illustrates the outline of the external-microphone setting process at Step S100 of FIG. 30.

As illustrated in FIG. 31, when the external-input detecting circuit 22 first has detected the external microphone 100 (Step S11: Yes), the process proceeds to Step S12 described later. Conversely, when the external-input detecting circuit 22 has not detected the external microphone 100 (Step S11: No), the process proceeds to Step S17 described later.

At Step S12, arrangement information about the external microphone 100 is set, and when a command signal input from the input unit 25 indicates that the external microphone 100 is in a perpendicular state with respect to the information acquiring apparatus 2 (Step S13: Yes), the audio-file generating circuit 302 sets the recording channel number in accordance with the command signal input from the input unit 25 (Step S14). For example, the audio-file generating circuit 302 sets four channels in the item related to the recording channel in the audio file containing audio data in accordance with the command signal input from the input unit 25.

Then, the audio-file generating circuit 302 sets the type of the external microphone 100 in accordance with the command signal input from the input unit 25 (Step S15). Specifically, the audio-file generating circuit 302 sets the type that corresponds to the command signal input from the input unit 25 in the item related to the type of the external microphone 100 in the audio file and sets a perpendicular state (perpendicular arrangement) or a parallel state (parallel arrangement) in the item related to arrangement information on the external microphone 100. In this case, through the input unit 25, a user further sets positional relation information about the positional relation of the third microphone 102 and the fourth microphone 103 provided on the external microphone 100 as being related to the type and the arrangement information. Here, the positional relation information is information that indicates the positional relation (XYZ coordinates) of each of the third microphone 102 and the fourth microphone 103 when the insertion plug 101 is regarded as the center. The positional relation information may include directional characteristics of each of the third microphone 102 and the fourth microphone 103 and the angle of each of the third microphone 102 and the fourth microphone 103 with a vertical direction passing the insertion plug 101 as a reference. Furthermore, the audio-file generating circuit 302 may acquire positional relation information from information stored in the memory 26 of the information acquiring apparatus 2 on the basis of, for example, the identification information for identifying the external microphone 100 or may acquire positional relation information from a server, or the like, via the communication circuit 27, or a user may cause the communication circuit 27 to perform network communications via the input unit 25 so that the information acquiring apparatus 2 acquires positional relation information from other devices, servers, or the like. A surface of the external microphone 100 may be provided with positional relation information on the third microphone 102 and the fourth microphone 103.

Then, the audio-file generating circuit 302 sets four-channel recording that is recording by using the first microphone 20, the second microphone 21, the third microphone 102, and the fourth microphone 103 in an audio file (Step S16). Here, according to the first embodiment, as the external microphone 100 includes the third microphone 102 and the fourth microphone 103, four channel recording is set; however, when the external microphone 100 is any one of the third microphone 102 and the fourth microphone 103, the audio-file generating circuit 302 sets three channel recording in an audio file. After Step S15, the information acquiring apparatus 2 returns to the main routine of FIG. 30.

At Step S13, when a command signal input from the input unit 25 indicates that the external microphone 100 is not in a perpendicular state with respect to the information acquiring apparatus 2 (the case of a parallel state) (Step S13: No), the audio-file generating circuit 302 sets 1/2 channel recording that is recording by using the first microphone 20 and the second microphone 21 in an audio file (Step S17). After Step S16, the information acquiring apparatus 2 returns to the main routine of FIG. 30.

With reference back to FIG. 30, the step subsequent to Step S101 is explained. As Steps S101 to S123 are the same as those described above in FIG. 3, detailed explanations are omitted. Furthermore, at Step S109, the audio-source position estimating circuit 295 estimates the positions of the audio sources on the basis of the audio data produced by each of the first microphone 20 and the second microphone 21.

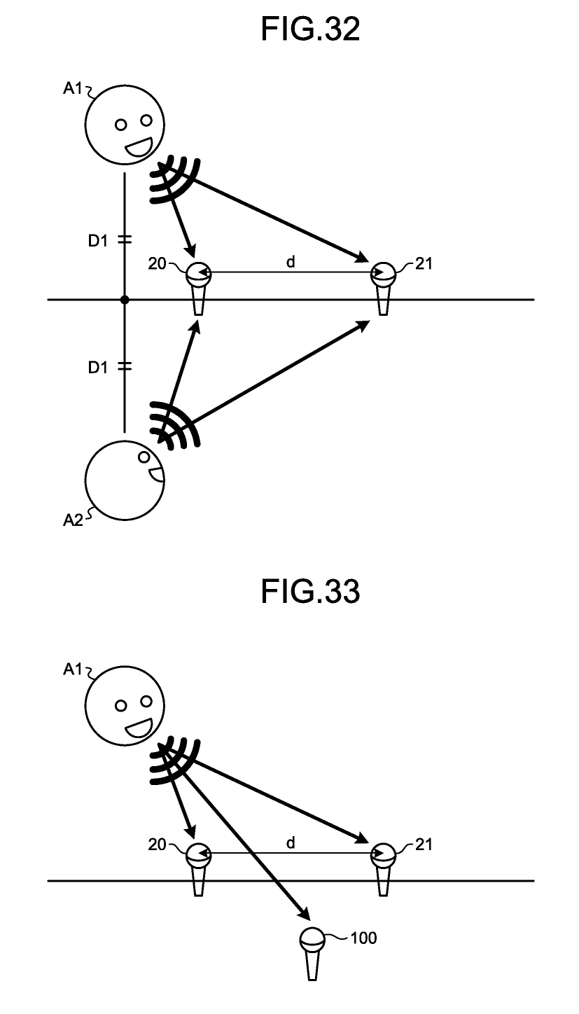

FIG. 32 is a diagram that schematically illustrates the arrival times of two audio sources in the same distance. FIG. 33 is a diagram that schematically illustrates a calculation situation where the audio-source position estimating circuit 295 calculates an arrival time difference with respect to a single audio source in the circumstance of FIG. 32.

As illustrated in FIG. 33, when the audio sources A1, A2 are located in an identical distance d1, a difference in the arrival times when an audio signal reaches the first microphone 20 and the second microphone 21, respectively, is the same and therefore it is difficult for the audio-source position estimating circuit 295 to estimate the positions of the audio sources A1, A2. When the external microphone 100 is inserted in a direction perpendicular to the longitudinal direction of the upper surface of each of the first microphone 20 and the second microphone 21 provided in the information acquiring apparatus 2, there is a difference between the arrival time when an audio signal reaches each of the first microphone 20 and the second microphone 21 and the arrival time when an audio signal reaches the external microphone 100, as illustrated in FIG. 33; therefore, the audio-source position estimating circuit 295 is capable of estimating the position of each audio source in a depth direction by using multiple pieces of audio data generated by the first microphone 20, the second microphone 21, and the external microphone 100 (at least any one of the third microphone 102 and the fourth microphone 103).

In the explanation of FIG. 32, the audio-source position estimating circuit 295 uses the positional relation among the three microphones (the first microphone 20, the second microphone 21, and the external microphone 100); however, this is not a limitation and, in accordance with the type of the external microphone 100, six directions may be calculated by using a positional relation in six combinations of four microphones, a time difference (position difference) and an intensity of sound, and the like, and the position of an audio source may be estimated in three dimensions. Specifically, the audio-source position estimating circuit 295 uses a positional relation in six combinations, i.e., a first combination of the first microphone 20 and the second microphone 21, a second combination of the third microphone 102 and the fourth microphone 103, a third combination of the first microphone 20 and the third microphone 102, a fourth combination of the first microphone 20 and the fourth microphone 103, a fifth combination of the second microphone 21 and the third microphone 102, and a sixth combination of the second microphone 21 and the fourth microphone 103, a time difference and an intensity of sound to calculate six directions and estimate the position of an audio source in three dimensions.

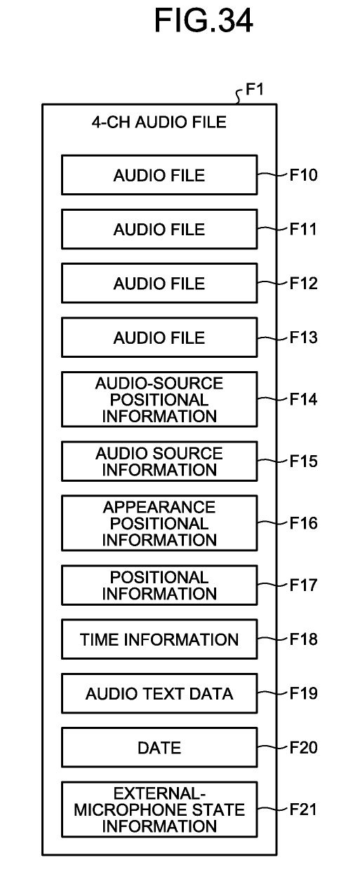

Furthermore, at Step S113, the audio-file generating circuit 302 generates an audio file that relates each piece of audio data on which the signal processing circuit 291 has conducted signal processing, audio-source positional information estimated by the audio-source position estimating circuit 295, multiple pieces of audio source information generated by the audio-source information generating circuit 298, an appearance position identified by the audio identifying circuit 299, positional information about the position of an index added by the index adding circuit 301 or time information about the time of an added index in audio data, audio text data generated by the text generating circuit 292, date, and external-microphone state information indicating the state of the external microphone 100, and stores the audio file in the audio file memory 262. For example, as illustrated in FIG. 34, the audio-file generating circuit 302 generates a 4-ch audio file F1 that relates audio files F10 to F13 that contain audio data in each recording channel on which the signal processing circuit 291 has conducted signal processing, audio-source positional information F14 estimated by the audio-source position estimating circuit 295, multiple pieces of audio source information F15 generated by the audio-source information generating circuit 298, appearance positional information F16 identified by the audio identifying circuit 299, positional information F17 about the position of an index added by the index adding circuit 301 or time information F18 about the time of an added index in audio data, audio text data F19 generated by the text generating circuit 292, date F20, and external-microphone state information F21, and stores the 4-ch audio file F1 in the audio file memory 262. Here, the external microphone information F21 includes positional relation information indicating the positional relation of four (three when the external microphone 100 is a single microphone) microphones (the first microphone 20, the second microphone 21, the third microphone 102, and the fourth microphone 103) including the external microphone 100 (the XYZ coordinates of each of the first microphone 20, the second microphone 21, the third microphone 102, and the fourth microphone 103 when the external-input detecting circuit 22 is regarded as the center), relation information indicating the relation state between the positional relation of each microphone and each of the audio files F10 to F13, arrangement information regarding a perpendicular state or a parallel state of the external microphone 100, and type information indicating the type of the external microphone 100 and the types of the first microphone 20 and the second microphone 21. After Step S113, the process proceeds to Step S114 described later. Furthermore, the audio-file generating circuit 302 may generate an audio file that relates audio data on which the signal processing circuit 291 has conducted signal processing and candidate timing information that defines candidate timing in which the text generating circuit 292 generates audio text data during a predetermined time period after the input unit 25 receives input of a command signal and store the audio-file in the audio file memory 262. That is, the audio-file generating circuit 302 may generate an audio file that relates audio data and candidate timing information that defines candidate timing during a predetermined time period after the input unit 25 receives input of a command signal and store the audio-file in the audio file memory 262.

According to the above-described second embodiment, as the external microphone 100 is attachable to the information acquiring apparatus 2 in a parallel state or a perpendicular state, normal recording or 360-degree spatial sound recording is enabled with a simple configuration, and when carried, the external microphone 100 is removed or set in a parallel state so as to be compact.

Furthermore, according to the second embodiment, the apparatus control circuit 29 switches the recording method of the information acquiring apparatus 2 in accordance with the attached state of the external microphone 100, whereby normal recording or 360-degree spatial sound recording may be conducted.

Moreover, according to the second embodiment, the display control circuit 303 causes the display 23 to display two-dimensional audio-source positional information about the position of each of the audio sources in accordance with an estimation result estimated by the audio-source position estimating circuit 295, whereby the position of a speaker during recording may be intuitively understood.

Furthermore, according to the second embodiment, the display control circuit 303 causes the display 23 to display audio-source positional information in accordance with a determination result determined by the display-position determining circuit 296, whereby the position of a speaker may be intuitively understood in accordance with the shape of the display 23.

Moreover, according to the second embodiment, the display-position determining circuit 296 determines the display position of each of the audio sources when the information acquiring apparatus 2 is in the center of the display area of the display 23, whereby the position of a speaker may be intuitively understood when the information acquiring apparatus 2 is in the center.

Furthermore, according to the second embodiment, the display control circuit 303 causes the display 23 to display multiple pieces of audio source information generated by the audio-source information generating circuit 298 as the audio-source positional information, whereby the sex and the number of speakers who have participated during recording may be intuitively understood.

Here, according to the second embodiment, the external microphone 100 is provided with each of the third microphone 102 and the fourth microphone 103; however, there may be at least one or more microphones, and there may be, for example, only the third microphone 102.

### Third Embodiment

Next, a third embodiment is explained. According to the third embodiment, there is a difference in the configuration from that of the information acquiring system 1A according to the above-described second embodiment. The configuration of an information acquiring system according to the third embodiment is explained below. The same components as those in the above-described second embodiment are attached with the same reference numeral, and explanation is omitted.

Configuration of the Information Acquiring System

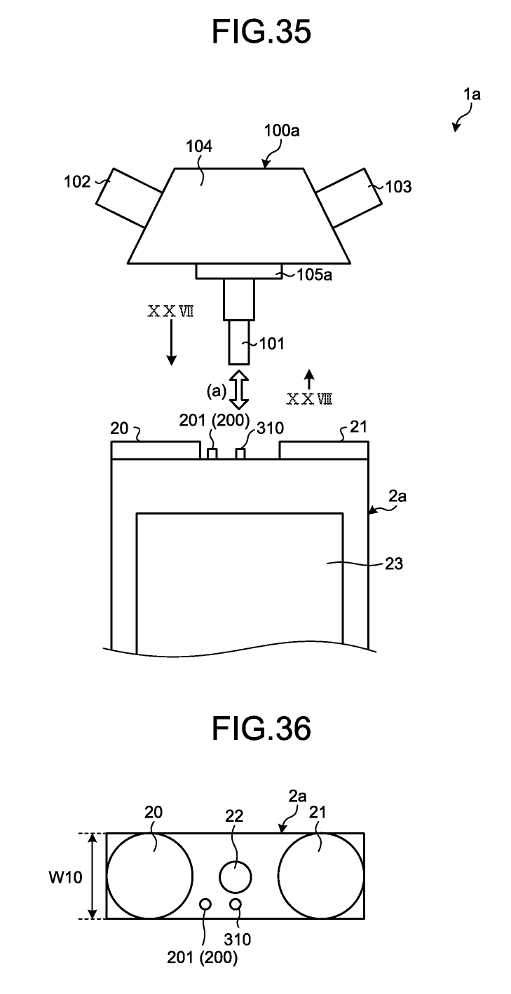

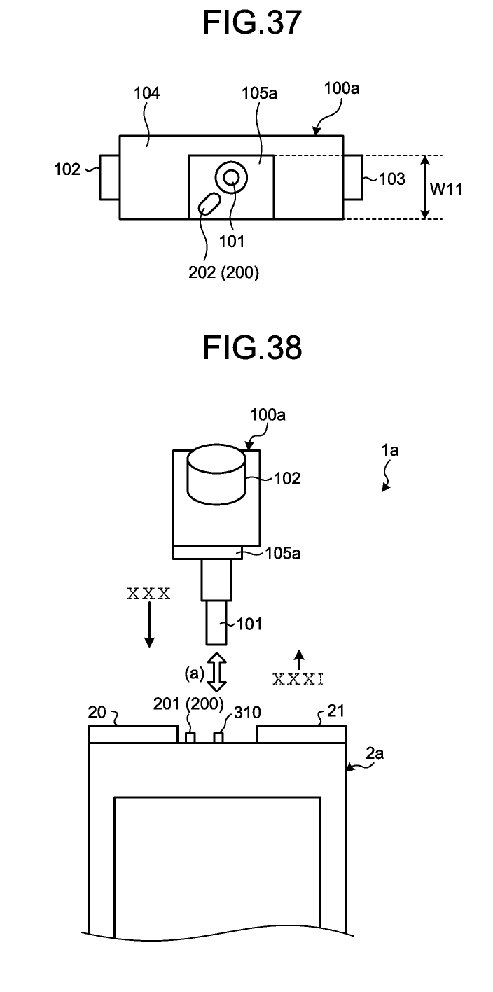

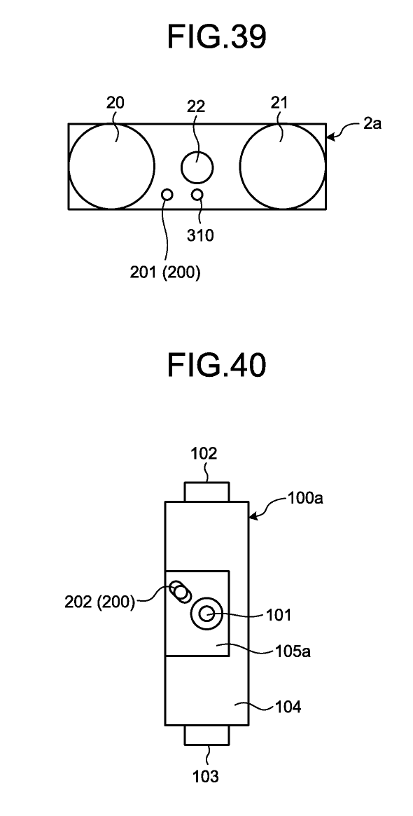

FIG. 35 is a schematic diagram that partially illustrates the relevant part of the information acquiring system according to the third embodiment. FIG. 36 is a top view of the information acquiring apparatus when viewed in the XXVII direction of FIG. 35. FIG. 37 is a bottom view of an external microphone when viewed in the XXVIII direction of FIG. 35. FIG. 38 is a schematic diagram that partially illustrates the relevant part of the information acquiring system according to the third embodiment. FIG. 39 is a top view of the information acquiring apparatus when viewed in the XXX direction of FIG. 38. FIG. 40 is a bottom view of the external microphone when viewed in the XXXI direction of FIG. 38.

An information acquiring system 1a illustrated in FIGS. 35 to 40 includes an information acquiring apparatus 2a, an external microphone 100a, a fixing section 200 for fixing in a perpendicular state, and a perpendicular detecting unit 310 that detects a perpendicular state.

The external microphone 100a includes a contact portion 105a instead of the contact portion 105 of the external microphone 100 according to the above-described first embodiment. The contact portion 105a has a plate-like shape. Furthermore, the contact portion 105a is formed such that its length in a lateral direction W11 is shorter than the length of the main body unit 104 in a lateral direction W10.

The fixing section 200 includes: a projection portion 201 that is provided on the top surface of the information acquiring apparatus 2a; and a groove portion 202 that is an elongate hole provided in the external microphone 100a.

The perpendicular detecting unit 310 is provided on the top surface of the information acquiring apparatus 2a so as to be movable back and forth. The perpendicular detecting unit 310 is brought into contact with the contact portion 105a of the external microphone 100a to be retracted while the external microphone 100a is in a perpendicular state with respect to the information acquiring apparatus 2a.

Method of Attaching the External Microphone

Next, an explanation is given of a method of securing the external microphone 100a to the information acquiring apparatus 2a.

Securing Method for Normal Recording

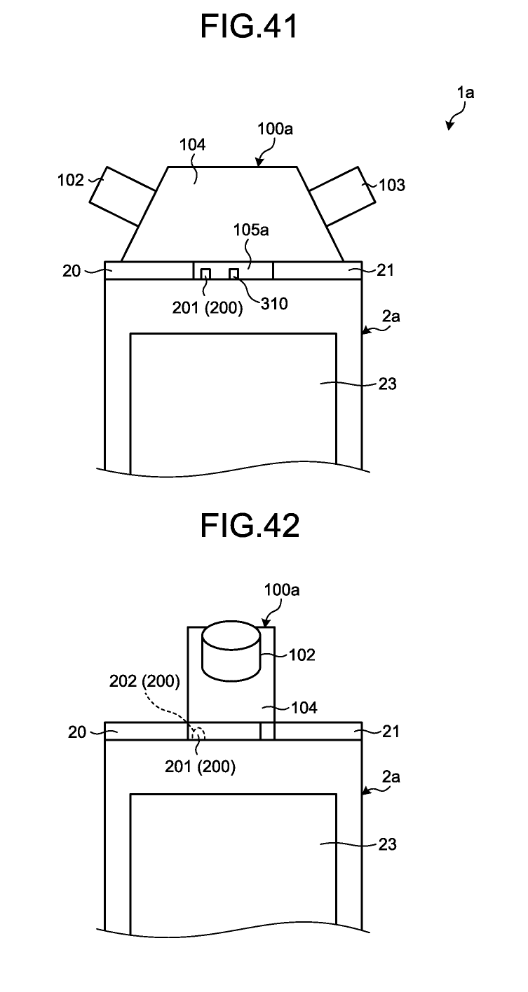

First, an explanation is given of a securing method when normal recording is conducted by using the external microphone 100a. As illustrated in FIG. 41, the insertion plug 101 of the external microphone 100a is inserted into the information acquiring apparatus 2a in a parallel state. In this case, each of the projection portion 201 and the perpendicular detecting unit 310 provided on the top surface of the information acquiring apparatus 2a is located in the space formed between the contact portion 105a and the information acquiring apparatus 2a without being in contact with the contact portion 105a. This allows the information acquiring apparatus 2a to conduct normal stereo recording by using the external microphone 100a.

Securing method for 360-degree spatial sound recording Next, an explanation is given of a securing method when 360-degree spatial sound recording is conducted by using the external microphone 100a. As illustrated in FIG. 42, the insertion plug 101 of the external microphone 100a is inserted into the information acquiring apparatus 2a in a perpendicular state with respect to the information acquiring apparatus 2a. In this case, the projection portion 201 provided on the top surface of the information acquiring apparatus 2a is engaged with the groove portion 202 that is an elongate hole provided on the external microphone 100a so that the external microphone 100a is fixed in a perpendicular state with respect to the information acquiring apparatus 2a. Furthermore, the perpendicular detecting unit 310 is in contact with the contact portion 105a of the external microphone 100a to be retracted. Thus, the information acquiring apparatus 2a is capable of conducting 360-degree spatial sound recording by using the external microphone 100a having a simple configuration and a high general versatility, and it may be ensured that the external microphone 100a is fixed in a perpendicular state.

Functional Configuration of the Information Acquiring Apparatus

Next, the functional configuration of the above-described information acquiring apparatus 2a is explained.

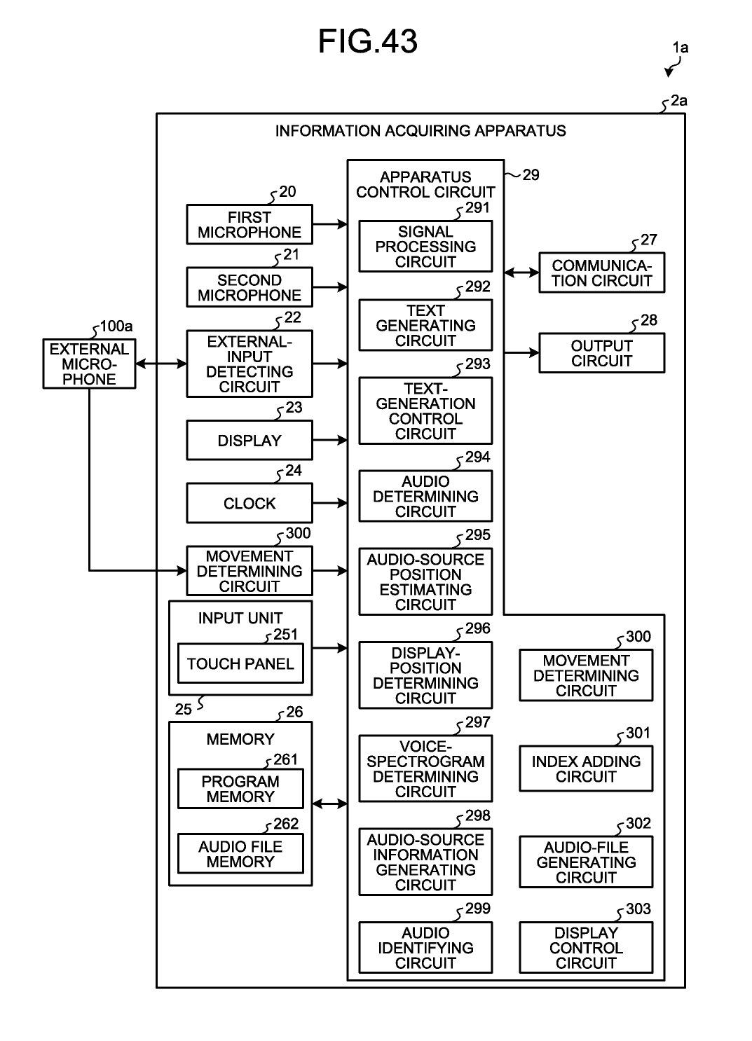

FIG. 43 is a block diagram that illustrates the functional configuration of the information acquiring apparatus 2a. The information acquiring apparatus 2a illustrated in FIG. 34 further includes the perpendicular detecting unit 310 in addition to the configuration of the information acquiring apparatus 2 according to the above-described first embodiment.

The perpendicular detecting unit 310 outputs, to the apparatus control circuit 29, a signal indicating that the external microphone 100a is in a perpendicular state when the external microphone 100a is in contact with the information acquiring apparatus 2a.

Process of the Information Acquiring Apparatus

Next, a process performed by the information acquiring apparatus 2a is explained. The process performed by the information acquiring apparatus 2a is the same as that performed by the information acquiring apparatus 2 according to the above-described first embodiment, but an external-microphone setting process is different. Specifically, according to the second embodiment, it is automatically detected that the external microphone 100a is inserted into the information acquiring apparatus 2a in a perpendicular state, and the perpendicular state gets fixed. Only the external-microphone setting process performed by the information acquiring apparatus 2a is explained below.

External-Microphone Setting Process

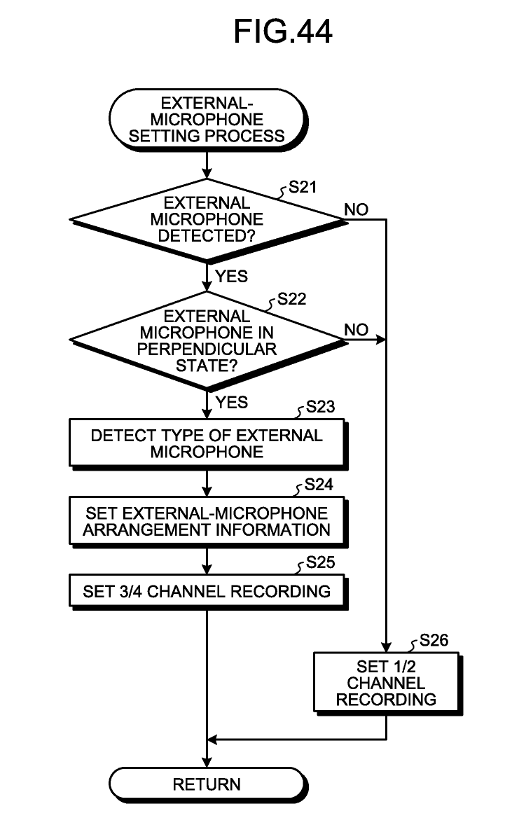

FIG. 44 is a flowchart that illustrates the outline of the external-microphone setting process.

As illustrated in FIG. 44, when the external-input detecting circuit 22 detects the external microphone 100a (Step S21: Yes), the information acquiring apparatus 2a proceeds to Step S22 described later. Conversely, when the external-input detecting circuit 22 does not detect the external microphone 100a (Step S21: No), the information acquiring apparatus 2a proceeds to Step S26 described later.

At Step S22, when the perpendicular detecting unit 310 has detected a perpendicular state of the external microphone 100a (Step S22: Yes), the information acquiring apparatus 2a proceeds to Step S23 described later. Conversely, when the perpendicular detecting unit 310 has not detected a perpendicular state of the external microphone 100a (Step S22: No), the information acquiring apparatus 2a proceeds to Step S26 described later.

At Step S23, the external-input detecting circuit 22 detects the type of the external microphone 100a inserted into the information acquiring apparatus 2a and notifies the type to the apparatus control circuit 29.

Then, arrangement information on the external microphone 100a is set (Step S24). Specifically, the audio-file generating circuit 302 sets a perpendicular state in the item related to the arrangement information on the external microphone 100 in an audio file.

Then, the audio-file generating circuit 302 sets 4-channel recording that is recording by using the first microphone 20, the second microphone 21, the third microphone 102, and the fourth microphone 103 in an audio file (Step S25). Here, according to the second embodiment, as the external microphone 100a includes the third microphone 102 and the fourth microphone 103, 4-channel recording is set; however, when the external microphone 100a is any one of the third microphone 102 and the fourth microphone 103, the audio-file generating circuit 302 sets 3-channel recording in an audio file. After Step S25, the information acquiring apparatus 2a returns to the main routine of FIG. 30 described above.

At Step S26, the audio-file generating circuit 302 sets ½ channel recording that is recording by using the first microphone 20 and the second microphone 21 in an audio file (Step S26). After Step S26, the information acquiring apparatus 2a returns to the main routine of FIG. 30.

According to the third embodiment described above, the external microphone 100a is attachable to the information acquiring apparatus 2a in a parallel state or a perpendicular state, whereby normal recording or 360-degree spatial sound recording is enabled with a simple configuration.

Furthermore, according to the third embodiment, the external microphone 100a is fixed with the fixing section 200 in a perpendicular state with respect to the information acquiring apparatus 2a, whereby 360-degree spatial sound recording is enabled by using the external microphone 100a having a simple configuration and a high general versatility, and it may be ensured that the external microphone 100a is fixed in a perpendicular state.

Furthermore, according to the third embodiment, the apparatus control circuit 29 switches a recording method of the information acquiring apparatus 2a in accordance with a detection result of the perpendicular detecting unit 310, whereby normal recording or 360-degree spatial sound recording is enabled with a simple configuration.

### Fourth Embodiment

Next, a fourth embodiment is explained. According to the fourth embodiment, there is a difference in the configuration from that of the information acquiring apparatus 2a according to the above-described third embodiment. Specifically, although the information acquiring apparatus 2a detects a perpendicular state of the external microphone 100a according to the above-described third embodiment, an external microphone detects a perpendicular state according to the fourth embodiment. A configuration of an information acquiring system according to the fourth embodiment is explained below. Here, the same components as those of the information acquiring system 1a according to the above-described third embodiment are attached with the same reference numerals, and explanations are omitted.

Configuration of the Information Acquiring System

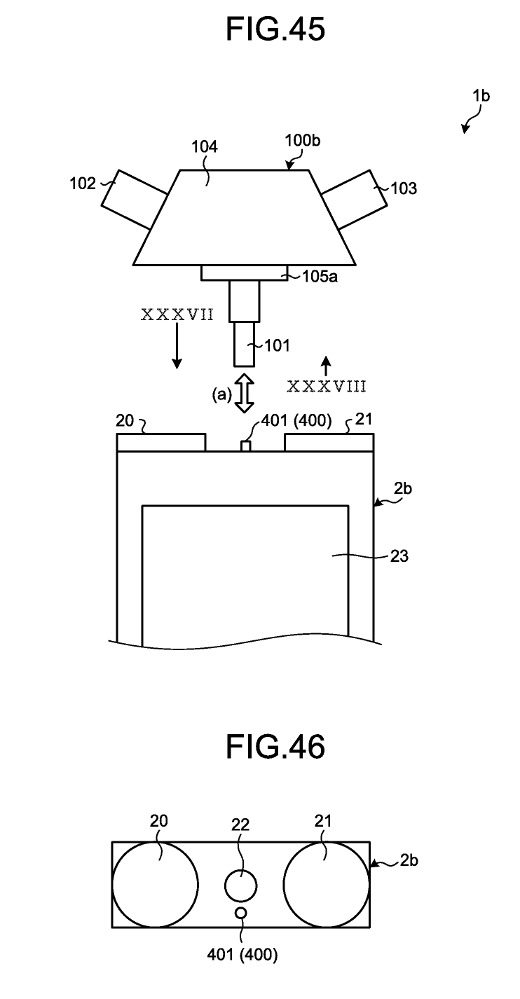

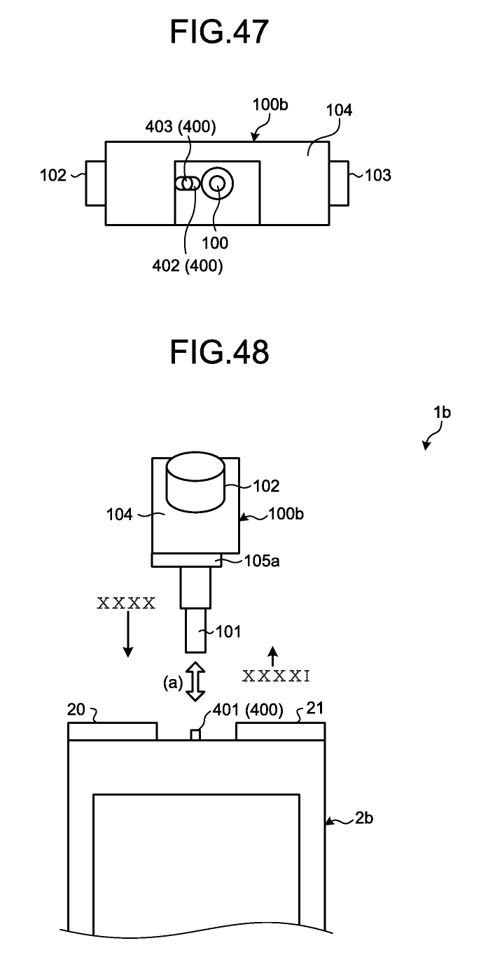

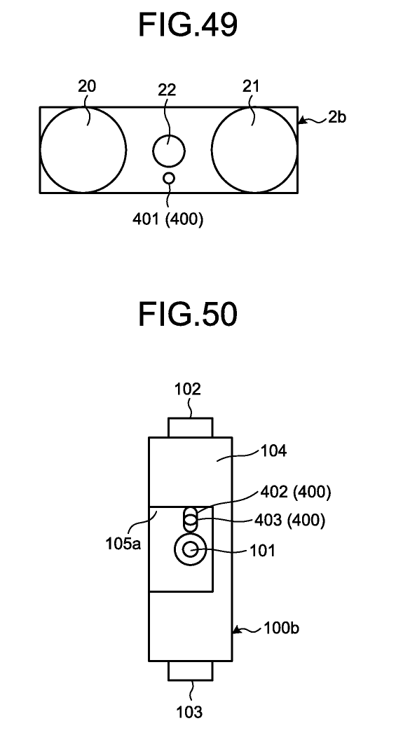

FIG. 45 is a schematic diagram that partially illustrates the relevant part of the information acquiring system according to the fourth embodiment. FIG. 46 is a top view of the information acquiring apparatus when viewed in the XXXVII direction of FIG. 45. FIG. 47 is a bottom view of the external microphone when viewed in the XXXVIII direction of FIG. 45. FIG. 48 is a schematic diagram that partially illustrates the relevant part of the information acquiring system according to the fourth embodiment. FIG. 49 is a top view of the information acquiring apparatus when viewed in the XXXX direction of FIG. 48. FIG. 50 is a bottom view of the external microphone when viewed in the XXXXI direction of FIG. 48.

An information acquiring system 1b illustrated in FIGS. 45 to 50 includes an information acquiring apparatus 2b, an external microphone 100b, and a fixing section 400 that is engaged in a perpendicular state and detects a perpendicular state.

The fixing section 400 includes a projection portion 401 provided on the top surface of the information acquiring apparatus 2b; a groove portion 402 that is an elongate hole provided in the external microphone 100b; and a perpendicular detecting unit 403 that is provided in the groove portion 402 and detects a perpendicular state of the external microphone 100b.

Method of Securing the External Microphone

Next, a method of securing the external microphone 100b to the information acquiring apparatus 2b is explained.

Securing method for normal recording First, an explanation is given of a securing method when normal recording is conducted by using the external microphone 100b. As illustrated in FIG. 51, with the external microphone 100b, the projection portion 401 provided on the top surface of the information acquiring apparatus 2b is located in the space formed between the contact portion 105a and the information acquiring apparatus 2b without being in contact with the contact portion 105a. This enables normal stereo recording by using the external microphone 100b.

Securing method for 360-degree spatial sound recording

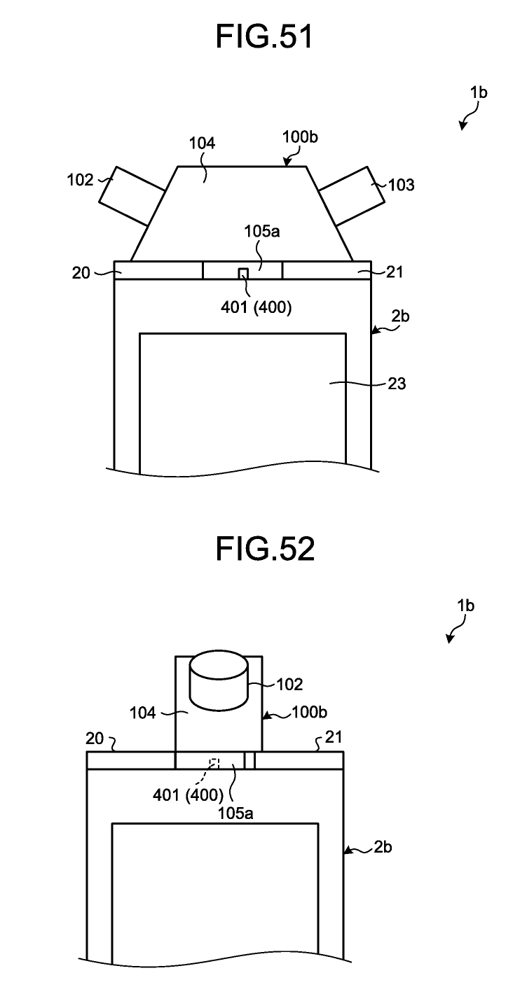

Next, an explanation is given of a securing method when 360-degree spatial sound recording is conducted by using the external microphone 100b. As illustrated in FIG. 52, the insertion plug 101 of the external microphone 100b is inserted into the information acquiring apparatus 2b in a perpendicular state with respect to the information acquiring apparatus 2b. In this case, the projection portion 401 provided on the top surface of the information acquiring apparatus 2b is engaged with the groove portion 402 that is an elongate hole provided in the external microphone 100b so that the external microphone 100b is fixed in a perpendicular state. Furthermore, the perpendicular detecting unit 403 is brought into contact with the projection portion 401 so as to detect that the external microphone 100b is in a perpendicular state and outputs a detection result to the apparatus control circuit 29 via the insertion plug 101. Thus, 360-degree spatial sound recording is enabled by using the external microphone 100b with a simple configuration and a high general versatility, and the external microphone 100b is fixable in a perpendicular state.

According to the above-described fourth embodiment, as the external microphone 100b is attachable to the information acquiring apparatus 2b in a parallel state or a perpendicular state, normal recording or 360-degree spatial sound recording is enabled with a simple configuration.

### Other Embodiments

Furthermore, although the information acquiring apparatus and the information processing apparatus according to this disclosure transmit and receive data in both directions via a communication cable, this is not a limitation, and the information processing apparatus may acquire an audio file containing audio data generated by the information acquiring apparatus via a server, or the like, or the information acquiring apparatus may transmit an audio file containing audio data to a server on a network.

Furthermore, the information processing apparatus according to this disclosure receives and acquires an audio file containing audio data from the information acquiring apparatus; however, this is not a limitation, and audio data may be acquired via an external microphone, or the like.

Furthermore, for explanations of the flowcharts in this specification, a sequential order of steps in process is indicated by using terms such as “first”, “next”, and “then”; however, the sequential order of a process necessary to implement this disclosure is not uniquely defined by using those terms. That is, the sequential order of a process in a flowchart described in this specification may be changed to such a degree that there is no contradiction. Furthermore, although a program is configured by simple branch procedures as described above, the program may also have branches by comprehensively evaluating more determination items. In such a case, it is possible to also use a technology of artificial intelligence that conducts machine learning by repeatedly performing learning while a user is prompted to perform manual operation. Furthermore, deep learning may be conducted by inputting further complex conditions due to learning of operation patterns conducted by many experts.

Furthermore, the apparatus control circuit and the information-processing control circuit according to this disclosure may include a processor and storage such as a memory. Here, in the processor, the function of each unit may be implemented by individual hardware, or the functions of units may be implemented by integrated hardware. For example, it is possible that the processor includes hardware and the hardware includes at least any one of a circuit that processes digital signals and a circuit that processes analog signals. For example, the processor may be configured by using one or more circuit devices (e.g., IC) installed on a circuit board or one or more circuit elements (e.g., resistor or capacitor). The processor may be, for example, a central processing unit (CPU). Here, not only a CPU but also various processors, such as graphics processing unit (GPU) or digital signal processor (DSP), may be used as the processor. Furthermore, the processor may be a hardware circuit using an ASIC. Furthermore, the processor may include an amplifier circuit, a filter circuit, or the like, that processes analog signals. The memory may be a semiconductor memory such as SRAM or DRAM, a register, a magnetic storage device such as a hard disk device, or an optical storage device such as an optical disk device. For example, the memory stores commands that are readable by a computer; thus, when the command is executed by a processor, a function of each unit, such as image diagnosis support system, is implemented. Here, the command may be a command in a command set with which a program is configured or may be a command that instructs a hardware circuit in the processor to perform operation.

The speaker and the display according to this disclosure may be connected with any type of digital data communication such as a communication network or a medium. Examples of the communication network include LAN, WAN, computer and network that form the Internet.

Furthermore, in the specification or drawings, if a term is described together with a different term having a broad meaning or the same meaning at least once, it is replaceable with the different term in any part of the specification or drawings. Thus, various modifications and applications are possible without departing from the scope of the disclosure.

As described above, this disclosure may include various embodiments that are not described here, and various design changes, and the like, may be made within the range of a specific technical idea.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information acquiring apparatus comprising:
a display that displays an image thereon;
a plurality of microphones provided at different positions to collect a sound produced by each of audio sources and generate audio data;
an audio-source position estimating circuit that estimates a position of each of the audio sources based on the audio data generated by each of the microphones; and
a display control circuit that causes the display to present audio-source positional information about a position of each of the audio sources in accordance with an estimation result estimated by the audio-source position estimating circuit.

2. The information acquiring apparatus according to claim 1, further comprising a display-position determining circuit that determines a display position of each of the audio sources on a display area of the display in accordance with a shape of the display area of the display and an estimation result estimated by the audio-source position estimating circuit, wherein
the display control circuit causes the display to display the audio-source positional information in accordance with a determination result determined by the display-position determining circuit.

3. The information acquiring apparatus according to claim 2, further comprising:
a voice-spectrogram determining circuit that generates audio information based on each speech produced by speakers, regarding each of the speakers; and
an audio-source information generating circuit that generates, as the audio information, an icon schematically illustrating the speaker by comparing pitches of voices produced by speakers, based on multiple pieces of audio source information about the respective audio sources.

4. The information acquiring apparatus according to claim 2, further comprising an audio-source information generating circuit that generates icons schematically illustrating speakers in different display forms, based on any one of a length and a clarity of voice produced by the speakers based on audio source information, regarding each of the speakers, on each speech produced by the speakers.

5. The information acquiring apparatus according to claim 2, wherein the display-position determining circuit determines the display position with respect to the information acquiring apparatus disposed in a center of the display area of the display unit.

6. The information acquiring apparatus according to claim 2, further comprising:
a voice-spectrogram determining circuit that determines a volume of voice in each speech produced by each of the speakers, regarding each of the speakers, based on the audio data; and
an audio-source information generating circuit that generates, as audio source information, icons schematically illustrating the respective speakers by comparing volumes of voices of the respective speakers determined by the voice-spectrogram determining circuit.

7. The information acquiring apparatus according to claim 2, further comprising an audio-source information generating circuit that generates audio source information in which icons schematically illustrating speakers are different from each other, regarding each of the speakers in accordance with a length of voice and a volume of voice in each speech produced by each of the speakers, based on the audio data.

8. The information acquiring apparatus according to claim 2, wherein the display-position determining circuit determines the display position when the information acquiring apparatus is in a center of the display area of the display.

9. The information acquiring apparatus according to claim 8, further comprising:
a voice-spectrogram determining circuit that determines a voice spectrogram from each of the audio sources based on the audio data; and
an audio-source information generating circuit that generates multiple pieces of audio source information regarding each of the audio sources in accordance with a determination result determined by the voice-spectrogram determining circuit, wherein
the display control circuit causes the display to display the pieces of audio source information as the audio-source positional information.

10. The information acquiring apparatus according to claim 9, further comprising:
an audio identifying circuit that identifies an appearance position at which each voice spectrogram, determined by the voice-spectrogram determining circuit, appears in the audio data; and
an audio-file generating circuit that generates an audio file that relates the audio data, the audio-source positional information, the pieces of audio source information, and the appearance position and stores the audio file in a recording medium.

11. The information acquiring apparatus according to claim 10, further comprising a movement determining circuit that determines whether each of the audio sources is moving in accordance with an estimation result estimated by the audio-source position estimating circuit and a determination result determined by the voice-spectrogram determining circuit, wherein
the audio-source information generating circuit adds information indicating a movement to the audio source information on the audio source that is moving as determined by the movement determining circuit.

12. The information acquiring apparatus according to claim 1, wherein the microphones are attachable to and detachable from the information acquiring apparatus.

13. The information acquiring apparatus according to claim 1, further comprising an external microphone that is attachable to and detachable from the information acquiring apparatus.

14. The information acquiring apparatus according to claim 1, further comprising an external microphone that includes a main body unit that is substantially cuboidal; and
a microphone that is provided near at least one of ends in a longitudinal direction of the main body unit to collect a sound produced by each of the audio sources and generate audio data, wherein the external microphone is detachably attached to the information acquiring apparatus in a parallel state where a straight line passing each of the microphones is in parallel with the longitudinal direction of the main body unit or in a perpendicular state where the straight line is perpendicular to the longitudinal direction.

15. The information acquiring apparatus according to claim 14, further comprising a fixing section that fixes the external microphone to the information acquiring apparatus in the perpendicular state.

16. The information acquiring apparatus according to claim 14, further comprising a perpendicular detecting circuit that detects the perpendicular state.

17. The information acquiring apparatus according to claim 16, further comprising an apparatus control circuit that switches a recording method of the information acquiring apparatus in accordance with a detection result of the perpendicular detecting circuit.

18. A display method implemented by an information acquiring apparatus, the display method comprising:
estimating positions of audio sources based on audio data generated by each of microphones that are provided at different positions to collect a sound generated by each of the audio sources and generate audio data; and
causing the display to display audio-source positional information about a position of each of the audio sources in accordance with an estimation result estimated.

19. A non-transitory computer-readable recording medium having an executable program recorded, the program giving a command to a processor included in an information acquiring apparatus to execute:
estimating positions of audio sources based on audio data generated by each of microphones that are provided at different positions to collect a sound produced by each of the audio sources and generate audio data; and
causing the display to display audio-source positional information about a position of each of the audio sources in accordance with an estimation result estimated.
